(19) United States
(12) Patent Application Publication
(10) Pub. No.: US 2025/0350157 A1
(43) Pub. Date: Nov. 13, 2025

(54) TECHNIQUES FOR MANAGING POWER TRANSFER AND POWER SAVING IN COMMUNICATION SYSTEMS

(71) Applicant: QUALCOMM INCORPORATED, San Diego, CA (US)

(72) Inventors: Ahmed Elshafie, San Diego, CA (US); Ahmed Attia Abotabl, San Diego, CA (US); Hung Dinh Ly, San Diego, CA (US); Yuchul Kim, San Diego, CA (US); Zhikun Wu, Beijing (CN); Linhai He, San Diego, CA (US); Krishna Kiran Mukkavilli, San Diego, CA (US); Tingfang Ji, San Diego, CA (US); Danlu Zhang, San Diego, CA (US)

(21) Appl. No.: 18/867,359

(22) PCT Filed: Aug. 3, 2022
(86) PCT No.: PCT/CN2022/109867

§ 371 Date: Nov. 19, 2024

(51) Int. Cl. H02J 50/80; H04B 5/79; H04W 76/14

(52) U.S. Cl. CPC H02J 50/80; H04B 5/79; H04W 76/14

(57) ABSTRACT

Methods, systems, and devices for wireless communication are described. A user equipment (UE) may receive signaling indicating a configuration associated with a first mode of a set of modes. The first mode corresponding to a first transfer supported by a network entity and a first charging rate associated with the first transfer. The UE may receive a signal based on the indicated configuration. The signal may correspond to the first transfer. The UE may charge a source associated with the UE based on the received signal and in accordance with the first charging rate associated with the first transfer.

### CROSS REFERENCE

The present application is a 371 national stage filing of International PCT Application No. PCT/CN2022/109867 by Elshafie et al. entitled “TECHNIQUES FOR MANAGING POWER TRANSFER AND POWER SAVING IN COMMUNICATION SYSTEMS,” filed Aug. 3, 2022, which is assigned to the assignee hereof, and which is expressly incorporated by reference in its entirety herein.

### INTRODUCTION

The following relates to wireless communication, including techniques for power management in communication systems.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a UE is described. The method may include receiving, from a network entity, signaling indicating a configuration associated with a respective mode of a set of modes, the respective mode corresponding to a respective transfer supported by the network entity and a respective charging rate associated with the respective transfer, receiving, from the network entity, a signal based on the indicated configuration, where the signal corresponds to the respective transfer, and charging of a source associated with the UE based on the received signal and in accordance with the respective charging rate associated with the respective transfer.

An apparatus for wireless communication at a UE is described. The apparatus may include a processor; and memory coupled with the processor, the processor configured to receive, from a network entity, signaling indicating a configuration associated with a respective mode of a set of modes, the respective mode corresponding to a respective transfer supported by the network entity and a respective charging rate associated with the respective transfer, receive, from the network entity, a signal based on the indicated configuration, where the signal corresponds to the respective transfer, and charge of a source associated with the UE based on the received signal and in accordance with the respective charging rate associated with the respective transfer.

Another apparatus for wireless communication at a UE is described. The apparatus may include means for receiving, from a network entity, signaling indicating a configuration associated with a respective mode of a set of modes, the respective mode corresponding to a respective transfer supported by the network entity and a respective charging rate associated with the respective transfer, means for receiving, from the network entity, a signal based on the indicated configuration, where the signal corresponds to the respective transfer, and means for charging of a source associated with the UE based on the received signal and in accordance with the respective charging rate associated with the respective transfer.

A non-transitory computer-readable medium storing code for wireless communication at a UE is described. The code may include instructions executable by a processor to receive, from a network entity, signaling indicating a configuration associated with a respective mode of a set of modes, the respective mode corresponding to a respective transfer supported by the network entity and a respective charging rate associated with the respective transfer, receive, from the network entity, a signal based on the indicated configuration, where the signal corresponds to the respective transfer, and charge of a source associated with the UE based on the received signal and in accordance with the respective charging rate associated with the respective transfer.

Some examples of the method, apparatuses, and non-transitory computer-readable medium described herein may further include operations, features, means, or instructions for receiving a control signal that enables the charging of the source associated with the UE, the control signal includes one or more of a layer-1 (L1) signal, a layer-2 (L2) signal, or a layer-3 (L3) signal and where charging of the source associated with the UE may be based on the received control signal.

Some examples of the method, apparatuses, and non-transitory computer-readable medium described herein may further include operations, features, means, or instructions for receiving a control signal that disables the charging of the source associated with the UE, the control signal includes one or more of a L1 signal, a L2 signal, or a L3 signal and terminating the charging of the source associated with the UE based on the received control signal.

Some examples of the method, apparatuses, and non-transitory computer-readable medium described herein may further include operations, features, means, or instructions for charging of the source associated with the UE may be based on the configuration and irrespective of one or more of a L1 signal, a L2 signal, or a L3 signal enabling or disabling the charging of the source. In some examples of the method, apparatuses, and non-transitory computer-readable medium described herein, the set of modes includes power modes, power saving modes, energy saving modes, communications modes, or a combination thereof. Additionally or alternatively, the first transfer includes a power transfer, an energy transfer, or both. Additionally or alternatively, the signal includes a power signal, an energy signal, or both. Additionally or alternatively, the charging rate includes a power charging rate, an energy charging rate, or both.

Some examples of the method, apparatuses, and non-transitory computer-readable medium described herein may further include operations, features, means, or instructions for determining a respective waveform for the respective mode based on the configuration, the received signal corresponds to the determined respective waveform, and the determined respective waveform corresponds to the respective charging rate and where charging of source associated with the UE may be based on the determined respective waveform.

In some examples of the method, apparatuses, and non-transitory computer-readable medium described herein, the determined respective waveform includes a narrowband waveform or a broadband waveform.

In some examples of the method, apparatuses, and non-transitory computer-readable medium described herein, the determined respective waveform corresponds to a respective frequency based on the respective charging rate.

In some examples of the method, apparatuses, and non-transitory computer-readable medium described herein, the received signal corresponds to a beamformed signal of the respective waveform.

Some examples of the method, apparatuses, and non-transitory computer-readable medium described herein may further include operations, features, means, or instructions for determining timing information to charge the source associated with the UE based on a radio resource control configuration or a medium access control-control element (MAC-CE), the timing information indicating a charging time interval for the charging of the source associated with the UE, the charging time interval including a beginning period and an ending period, and the media access control (MAC)-CE activating or deactivating the charging of the source associated with the UE.

In some examples of the method, apparatuses, and non-transitory computer-readable medium described herein, the timing information to charge the source associated with the UE may be based on data traffic between the network entity and the UE.

Some examples of the method, apparatuses, and non-transitory computer-readable medium described herein may further include operations, features, means, or instructions for transmitting feedback information that indicates a respective waveform, a frequency associated with the respective waveform, or a set of spatial parameters, or a combination thereof and where the respective charging rate may be based on the respective waveform, the frequency associated with the respective waveform, the set of spatial parameters, or a combination thereof.

Some examples of the method, apparatuses, and non-transitory computer-readable medium described herein may further include operations, features, means, or instructions for receiving control signaling that indicates a respective waveform associated with the respective mode, where the respective waveform corresponds to an uplink waveform, a downlink waveform, or both and communicating with the network entity in accordance with the uplink waveform, the downlink waveform, or both.

Some examples of the method, apparatuses, and non-transitory computer-readable medium described herein may further include operations, features, means, or instructions for selecting the respective waveform from a set of waveforms based on the received control signaling and the respective mode associated with the respective waveform.

Some examples of the method, apparatuses, and non-transitory computer-readable medium described herein may further include operations, features, means, or instructions for determining a time interval associated with use of the respective waveform based on the received control signaling and where communicating with the network entity may be based on the determined time interval associated with the use of the respective waveform.

In some examples of the method, apparatuses, and non-transitory computer-readable medium described herein, receiving the control signaling may include operations, features, means, or instructions for receiving a radio resource control message that indicates the respective waveform associated with the respective mode.

In some examples of the method, apparatuses, and non-transitory computer-readable medium described herein, receiving the control signaling may include operations, features, means, or instructions for receiving a MAC-CE that indicates the respective waveform associated with the respective mode, the MAC-CE activating or deactivating the respective waveform associated with the respective mode.

In some examples of the method, apparatuses, and non-transitory computer-readable medium described herein, receiving the control signaling may include operations, features, means, or instructions for receiving a downlink control information (DCI) that indicates the respective waveform associated with the respective mode, the DCI activating or deactivating the respective waveform associated with the respective mode.

Some examples of the method, apparatuses, and non-transitory computer-readable medium described herein may further include operations, features, means, or instructions for determining an offset time interval for switching to the respective waveform based on the configuration, where the offset time interval may be based on a type of the respective waveform, the type of respective waveform corresponding to downlink or uplink, or both.

Some examples of the method, apparatuses, and non-transitory computer-readable medium described herein may further include operations, features, means, or instructions for receiving, from the network entity, a discontinuous reception (DRX) configuration including one or more DRX parameters associated with the respective mode, timing information recommended by the UE, a resource allocation preferred by the UE, a power allocation preferred by the UE, or a combination thereof and where receiving the signal may be based on the received DRX configuration.

Some examples of the method, apparatuses, and non-transitory computer-readable medium described herein may further include operations, features, means, or instructions for accumulating energy based on the received signal and where charging of the source associated with the UE may be based on the accumulated energy.

In some examples of the method, apparatuses, and non-transitory computer-readable medium described herein, the signal includes an electromagnetic (EM) wave in a radio frequency spectrum or an optical spectrum of an EM spectrum.

In some examples of the method, apparatuses, and non-transitory computer-readable medium described herein, the respective mode corresponds to a type of UE and the UE corresponds to the type of UE.

In some examples of the method, apparatuses, and non-transitory computer-readable medium described herein, the type of UE corresponds to a type of energy harvesting circuit requirement, a transfer requirement, or a charging rate requirement, or any combination thereof.

In some examples of the method, apparatuses, and non-transitory computer-readable medium described herein, each mode of the set of modes associated with the network entity corresponds to a respective waveform of a set of waveforms.

In some examples of the method, apparatuses, and non-transitory computer-readable medium described herein, a first subset of modes corresponds to transfer supported by the network entity and a second subset of modes corresponds to transfer unsupported by the network entity.

A method for wireless communication at a network entity is described. The method may include outputting signaling indicating a configuration associated with a respective mode of a set of modes, the respective mode corresponding to a respective transfer supported by the network entity and a respective charging rate associated with the respective transfer and outputting a signal based on the indicated configuration, where the signal corresponds to the respective transfer.

An apparatus for wireless communication at a network entity is described. The apparatus may include a processor; and memory coupled with the processor, the processor configured to output signaling indicating a configuration associated with a respective mode of a set of modes, the respective mode corresponding to a respective transfer supported by the network entity and a respective charging rate associated with the respective transfer and output a signal based on the indicated configuration, where the signal corresponds to the respective transfer.

Another apparatus for wireless communication at a network entity is described. The apparatus may include means for outputting signaling indicating a configuration associated with a respective mode of a set of modes, the respective mode corresponding to a respective transfer supported by the network entity and a respective charging rate associated with the respective transfer and means for outputting a signal based on the indicated configuration, where the signal corresponds to the respective transfer.

A non-transitory computer-readable medium storing code for wireless communication at a network entity is described. The code may include instructions executable by a processor to output signaling indicating a configuration associated with a respective mode of a set of modes, the respective mode corresponding to a respective transfer supported by the network entity and a respective charging rate associated with the respective transfer and output a signal based on the indicated configuration, where the signal corresponds to the respective transfer.

In some examples of the method, apparatuses, and non-transitory computer-readable medium described herein, each mode of the set of modes associated with the network entity corresponds to a respective waveform of a set of waveforms.

In some examples of the method, apparatuses, and non-transitory computer-readable medium described herein, a first subset of modes corresponds to transfer supported by the network entity and a second subset of modes corresponds to transfer unsupported by the network entity.

Some examples of the method, apparatuses, and non-transitory computer-readable medium described herein may further include operations, features, means, or instructions for transmitting a control signal that enables the charging of the source associated with a UE, the control signal includes one or more of a L1 signal, a L2 signal, or a L3 signal.

Some examples of the method, apparatuses, and non-transitory computer-readable medium described herein may further include operations, features, means, or instructions for transmitting a control signal that disables the charging of the source associated with a UE, the control signal includes one or more of a L1 signal, a L2 signal, or a L3 signal.

Some examples of the method, apparatuses, and non-transitory computer-readable medium described herein may further include operations, features, means, or instructions for receiving feedback information that indicates a respective waveform, a frequency associated with the respective waveform, or a set of spatial parameters, or a combination thereof.

Some examples of the method, apparatuses, and non-transitory computer-readable medium described herein may further include operations, features, means, or instructions for transmitting control signaling that indicates a respective waveform associated with the respective mode, where the respective waveform corresponds to an uplink waveform, a downlink waveform, or both.

Some examples of the method, apparatuses, and non-transitory computer-readable medium described herein may further include operations, features, means, or instructions for transmitting a radio resource control message that indicates the respective waveform associated with the respective mode.

Some examples of the method, apparatuses, and non-transitory computer-readable medium described herein may further include operations, features, means, or instructions for transmitting a MAC-CE that indicates the respective waveform associated with the respective mode, the MAC-CE activating or deactivating the respective waveform associated with the respective mode.

Some examples of the method, apparatuses, and non-transitory computer-readable medium described herein may further include operations, features, means, or instructions for transmitting a DCI that indicates the respective waveform associated with the respective mode, the DCI activating or deactivating the respective waveform associated with the respective mode.

Some examples of the method, apparatuses, and non-transitory computer-readable medium described herein may further include operations, features, means, or instructions for transmitting a DRX configuration including one or more DRX parameters associated with the respective mode, timing information recommended by a UE, a resource allocation preferred by the UE, a power allocation preferred by the UE, or a combination thereof.

### BRIEF DESCRIPTION OF THE DRAWINGS

FIG. 1 illustrates an example of a wireless communications system that supports techniques for managing power transfer and power saving in communication systems in accordance with one or more aspects of the present disclosure.

FIG. 2 illustrates an example of a network architecture that supports techniques for managing power transfer and power saving in communication systems in accordance with one or more aspects of the present disclosure.

FIGS. 3 through 6 illustrate examples of wireless communications systems that support techniques for managing power transfer and power saving in communication systems in accordance with one or more aspects of the present disclosure.

FIG. 7 illustrates an example of a process flow that supports techniques for managing power transfer and power saving in communication systems in accordance with one or more aspects of the present disclosure.

FIGS. 8 and 9 show block diagrams of devices that support techniques for managing power transfer and power saving in communication systems in accordance with one or more aspects of the present disclosure.

FIG. 10 shows a block diagram of a communications manager that supports techniques for managing power transfer and power saving in communication systems in accordance with one or more aspects of the present disclosure.

FIG. 11 shows a diagram of a system including a device that supports techniques for managing power transfer and power saving in communication systems in accordance with one or more aspects of the present disclosure.

FIGS. 12 and 13 show block diagrams of devices that support techniques for managing power transfer and power saving in communication systems in accordance with one or more aspects of the present disclosure.

FIG. 14 shows a block diagram of a communications manager that supports techniques for managing power transfer and power saving in communication systems in accordance with one or more aspects of the present disclosure.

FIG. 15 shows a diagram of a system including a device that supports techniques for managing power transfer and power saving in communication systems in accordance with one or more aspects of the present disclosure.

FIGS. 16 and 17 show flowcharts illustrating methods that support techniques for managing power transfer and power saving in communication systems in accordance with one or more aspects of the present disclosure.

### DETAILED DESCRIPTION

A wireless communications system may include a device, such as a UE or a network entity (e.g., an eNodeB (eNB), a next-generation NodeB or a giga-NodeB, either of which may be referred to as a gNB, or some other base station), that supports wireless communications using one or multiple radio access technologies. Examples of radio access technologies include 4G systems, such as LTE systems, 5G systems, which may be referred to as NR systems, or other systems and radio technologies, including future systems and radio technologies not explicitly mentioned herein (e.g., sixth generation (6G) systems). In the wireless communications system, a network entity may support energy-efficient communications (also referred to as green communications), which may enable the network entity to experience energy-efficiency as well as resource-efficiency without compromising the quality of service (QOS) for a UE.

A device (e.g., a UE, a network entity, or both) may support various modes of operation to support energy transfer and power saving. For example, the UE may be configured to be active (e.g., during an ON duration) and inactive periodically over time to decrease battery power consumption when in a DRX mode. Additionally or alternatively, the network entity may have a reduced number of antennas activated, adapt the bandwidth of energy signaling during energy transfer, or use other techniques to conserve energy based on network conditions when in a low power mode. The various modes may be referred to as power modes, power saving modes, energy saving modes, or communication modes.

In some cases, the device may switch between the modes in accordance with network traffic conditions in order to support energy-efficient communications. For example, a network entity may refrain from activating antennas at the network entity during periods of low network traffic in order to reduce energy consumption at the network entity. Additionally or alternatively, a UE may operate in a low power mode, such as a discontinuous reception (DRX) mode to conserve energy during periods of low network traffic. As described herein, the active state may refer to an ON state or an awake state of the UE. As described herein, the inactive state may refer to an OFF state or a sleep state of the UE.

A device may additionally, or alternatively, support energy harvesting. As described herein, energy harvesting may be defined as a process by which usable energy at the device may be derived from one or more external energy sources. For example, the device may perform energy harvesting by capturing energy from an external source and converting the captured energy into an energy type that may support operations (e.g., transmitting wireless communication, receiving wireless communication, among other operations) at the device. Examples of an external source that may be used for energy harvesting include radio frequency (RF) energy, light energy (e.g., lasers), or other types of energy not explicitly mentioned herein. The device may store the captured energy in a rechargeable power source, which may be referred to as a power source associated with the device. A rechargeable power source as described herein may be any storage unit, such as a battery or supercapacitor.

A device may have a target for performing energy-efficient communications and a target for performing energy harvesting. In some cases, the energy-efficient communications may conflict with the energy harvesting. For example, a network entity may aim to transfer an amount of energy to the UE so that the UE may perform energy harvesting. Additionally, the network entity may aim to reduce energy consumption at the network entity while performing energy-efficient communications. Because the network entity may lose energy by transferring energy to the UE, the network entity may be unable to save enough energy to meet energy-efficient communications targets for power efficiency in the wireless communication system.

As described herein, a device may support managing power efficiency by supporting techniques for managing power transfer, power saving, or both. In some examples, the network entity may transmit signaling to the UE indicating a configuration associated with a mode of a set of modes for the UE. The mode may correspond to a transfer (e.g., an energy transfer, a power transfer) supported by the network entity and a charging rate (e.g., a power charging rate, an energy charging rate) associated with the transfer. As described herein, the charging rate may be defined as an accumulation of energy per time unit. A UE may receive a signal (e.g., an energy signal, a power signal) from the network entity based on the indicated configuration. The signal may correspond to the transfer (e.g., an energy or power transfer) via an RF signal or a light signal (e.g., a laser). The UE may charge a source (e.g., a power source, such as a battery) associated with the UE based on the received signal and in accordance with the charging rate associated with the transfer. As a result, the UE may charge the source of the UE based on accumulating energy from the received signal over a certain duration. Accordingly, the network entity may manage transfer by indicating a configuration to the UE that is associated with a mode, where the mode may or may not correspond to energy transfer supported by the network entity. If the configuration is associated with a mode that does not support energy transfer from the network entity to the UE, the network entity may save power at the network entity because the network entity may not expend power to transfer energy to the UE in such cases.

Aspects of the subject matter described herein may be implemented by a device to support power saving. For example, a network entity may avoid wasting energy by configuring a UE with a power mode such that the UE may support receiving an energy signal from the network entity. The network entity may increase power efficiency of energy transfer operations by configuring the UE with a power mode such that energy transfer to the UE is unsupported by the network entity during periods of low data traffic, and such that energy transfer to the UE is supported by the network entity during periods of high data traffic. Additionally, or alternatively, the network entity may avoid wasting energy by configuring a UE with a power mode such that the UE may perform energy harvesting operations with a reduced energy charging rate during periods of low traffic conditions, and such that the UE may perform energy harvesting operations with an increased energy charging rate during periods of high traffic conditions. By enabling the UE with a power mode configuration indicating a power mode associated with unsupported energy transfer by the network entity, the UE may be aware that the network entity may not transfer an energy signal to the UE. Thus, the UE may refrain from monitoring for the energy signal while configured for the power mode, optimizing power resources at the UE.

Aspects of the disclosure are initially described in the context of wireless communications systems. Aspects of the disclosure are further illustrated by and described with reference to apparatus diagrams, system diagrams, and flowcharts that relate to techniques for managing power transfer and power saving in communication systems.

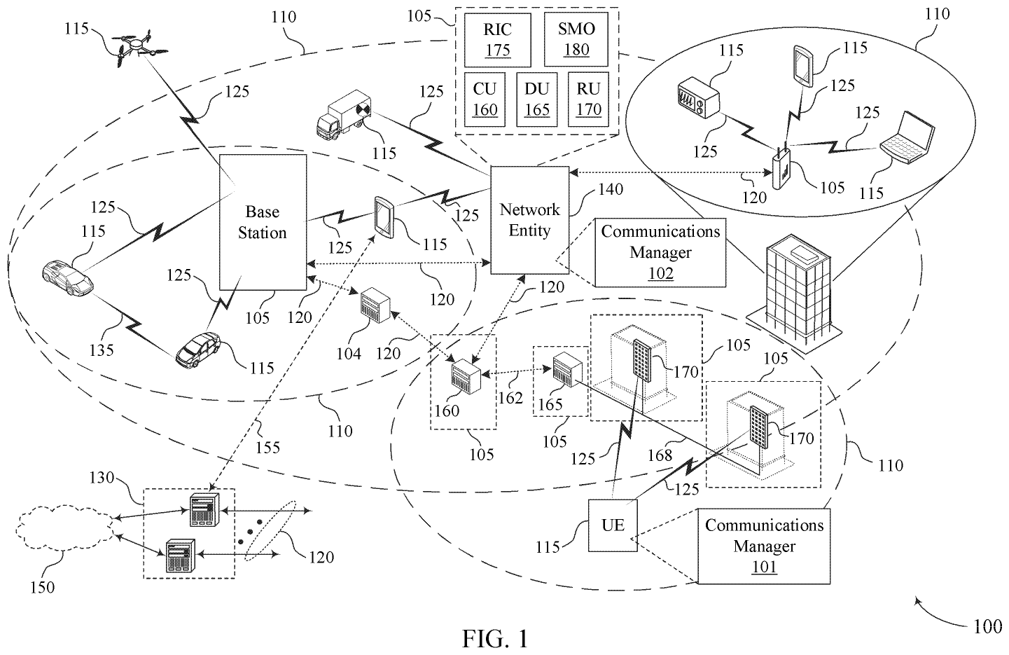

FIG. 1 illustrates an example of a wireless communications system 100 that supports techniques for managing power transfer and power saving in communication systems in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNB, a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node.

For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for managing power transfer and power saving in communication systems as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic (EM) spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

One or both of the network entity 105 or the UE 115 may support various waveforms for wireless communication (e.g., downlink communication, uplink communication) and energy communication (e.g., energy transfer). In some examples, for wireless communication, one or both of the network entity 105 or the UE 115 may support a single carrier waveform (e.g., a DFT-S-OFDM waveform) or a cyclic prefix-OFDM (CP-OFDM) waveform. A DFT-S-OFDM waveform may be based on a frequency-domain transform precoding at one or both of the network entity 105 or the UE 115 and a frequency-domain equalization at one or both of the network entity 105 or the UE 115. In some cases, one or both of the network entity 105 or the UE 115 may support efficient bandwidth utilization using a DFT-S-OFDM waveform compared to an SC-QAM waveform. Additionally, using a DFT-S-OFDM waveform may provide flexible bandwidth allocation to support larger bandwidth for wireless communication. An SC-QAM waveform may be based on a time-domain filtering (e.g., pulse shaping filters at one or both of the network entity 105 or the UE 115 and matched filtering/time-domain equalization at one or both of the network entity 105 or the UE 115). In some cases, one or both of the network entity 105 or the UE 115 may experience restricted bandwidth allocation when using SC-QAM waveforms for wireless communication.

In some cases, a DFT-S-OFDM waveform may be a preferred waveform for one or both of network entity 105 or the UE 115, for example, when the UE 115 is at a cell edge associated with the network entity 105. The DFT-S-OFDM waveform may be associated with a low peak to average power ratio (PAPR) characteristic and hence may allow an increased transmit power for the UE 115. For DFT-S-OFDM waveform-based transmissions, the UE 11 may support more robust modulation and coding scheme (MCS) options (e.g., lower code rates and pi/2 binary phase-shift keying (BPSK) modulation option). In some cases, a DFT-S-OFDM waveform-based transmission may be supported by a single layer transmission.

A CP-OFDM waveform may be a more spectrally efficient option for one or both of the network entity 105 or the UE 115 since it is associated with various MCS tables that provide more spectrally efficient MCSs and also allows multiple layers transmission. A CP-OFDM waveform-based transmission may be supported by the UE 115 when under cell coverage of the network entity 105. In some cases, the UE 115 may experience low or moderate mobility and may reside at different locations under a cell coverage range of the network entity 105 at different times and may be configured to use different transmission schemes according to experienced reception conditions (e.g., a lowest signal noise ratio (SNR) edge/cell edge or mid/high SNR range). To support this variability in mobility, the network entity 105 and the UE 115 may support a dynamic switching between DFT-S-OFDM and CP-OFDM schemes.

In some cases, one or both of the network entity 105 or the UE 115 may support a CP-OFDM waveform-based transmission for high RF spectrum bands (e.g., frequency range 4 (FR4) and beyond). The CP-OFDM waveform-based transmission may be backward compatible with other frequency ranges (e.g., frequency range one (FR1), frequency range 2 (FR2), and beyond (FR2x) waveforms). In some other cases, other single carrier waveforms might be supported by one or both of the network entity 105 or the UE 115 for other scenarios requiring high energy efficiency. In some examples, lower PAPR may correspond to a higher power amplifier efficiency for one or both of the network entity 105 or the UE 115. In some other examples, one or both of the network entity 105 or the UE 115 may achieve higher data rate by support massive spectrum availability. In some cases, to facilitate frequency domain equalization, CP may be introduced to create OFDM-like blocks or symbols. For example, guard interval (GI), which is a known sequence, may be considered as a special case of CP in this context.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to increase link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may increase throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The wireless communications system 100 may perform green communication by supporting energy efficient communications between a UE 115 and a network entity 105 and managing resource consumption. In some examples, the UE 115, the network entity 105, or both, may operate using different power modes and operations in order to save power while maintain network operations. The UE 115, the network entity 105, or both may contribute to supporting green communication in the wireless communications system 100 by switching power modes in accordance with network input and current data traffic conditions. For instance, the network entity 105 may include antennas that may be used to perform wireless communication in the wireless communications system 100. If a data traffic level associated with the wireless communications system 100 falls below a data traffic threshold, the network entity 105 may switch from a first power mode to a second power mode, where the second power mode consumes less power than the first power mode. In the second power mode, the network entity 105 may activate a fewer number of the antennas at the network entity 105 instead of activating all of the antennas, improving the performance of green communication.

A UE 115 may be configured to support energy harvesting-enabled communication services in the wireless communication system 100. For example, a UE 115 may support energy harvesting in which the UE 115 may accumulate energy in a rechargeable power source by harvesting energy from external sources (e.g., RF energy, optical energy, etc.). In some examples, a UE 115 may be configured without a power source (e.g., battery-less) or with limited energy storage (e.g., a capacitor device). In some examples, a UE 115 may be a passive IoT device, which may be configured to perform identification operations, tracking operations, sensing operations, among other examples. In some other examples, a UE may be configured to support power sourcing operations, security operations, access control/connectivity management operations, positioning operations, among other examples.

A network entity 105 may support energy transfer operations in which the network entity 105 may transfer energy to the UE 115 such that the UE 115 may harvest energy from the transferred energy in order to charge the rechargeable power source of the UE 115. Because the network entity 105 may lose energy by transferring energy to the UE 115, the network entity 105 and the UE 115 may perform suboptimal green communication in the wireless communication system 100. Due the variability of data traffic conditions and network inputs, the network power efficiency of wireless communications between the UE 115 and the network entity 105 may be increased.

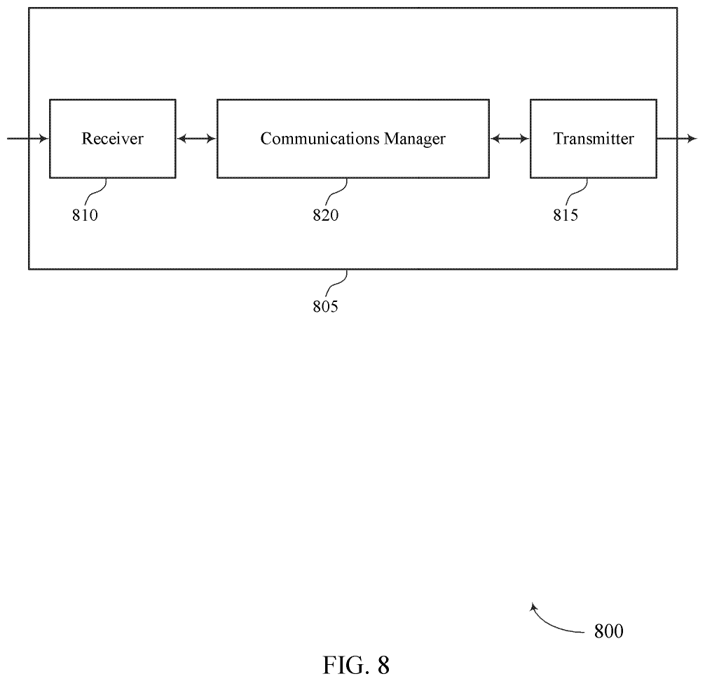

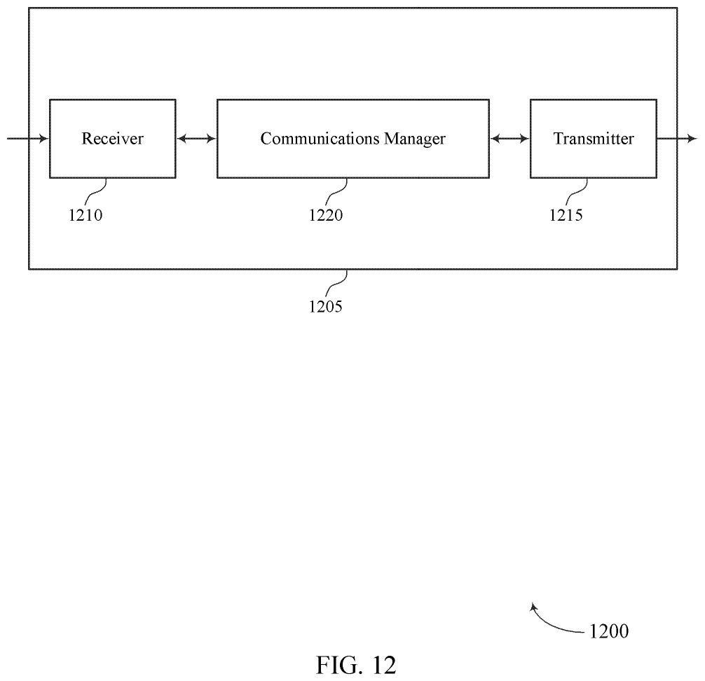

Various aspects of the present disclosure relate to enabling a network entity 105 and a UE 115 to support signaling related to techniques for managing power transfer and power saving in communication systems such as the wireless communications system 100. The UE 115 may include a communications manager 101 and the network entity 105 may include a communications manager 102 in accordance with examples as disclosed herein. The communications manager 101 may be an example of aspects of a communications manager as described in FIGS. 8 through 11. The communications manager 102 may be an example of aspects of a communications manager as described in FIGS. 12 through 15.

The communications manager 102 may output or transmit, and the communications manager 101 may receive or obtain, signaling that indicates a configuration associated with a mode of a set of modes for the UE 115, the mode corresponding to a transfer supported by the network entity 105 and a charging rate associated with the transfer. The communications manager 102 may output or transmit, in accordance with the indicated configuration, a signal that corresponds to the transfer associated with the mode of the UE 115. Based on the signaling exchanged between the communications manager 101 and the communications manager 102, the UE 115 may effectively communicate with the network entity 105 or other communication devices in the wireless communications system 100 as described herein.

In some cases, the network entity 105, the UE 115, or any combination thereof may be configured with circuitry that may support energy harvesting operations. The circuitry may include one or multiple circuit elements, such as resistors, transistors, capacitors, inductors, amplifiers, diodes, among other examples, that may be coupled (e.g., operatively, communicatively, functionally, electronically, or electrically) with each other to support energy harvesting operations at the network entity 105, the UE 115, or any combination thereof. The circuitry may receive energy from one or more external energy sources, as described herein, and may process (e.g., collect, convert, transform) the energy via the one or multiple circuit elements, such as resistors, transistors, capacitors, inductors, amplifiers, diodes, among other examples, to charge a power source of the network entity 105, the UE 115, or any combination thereof.

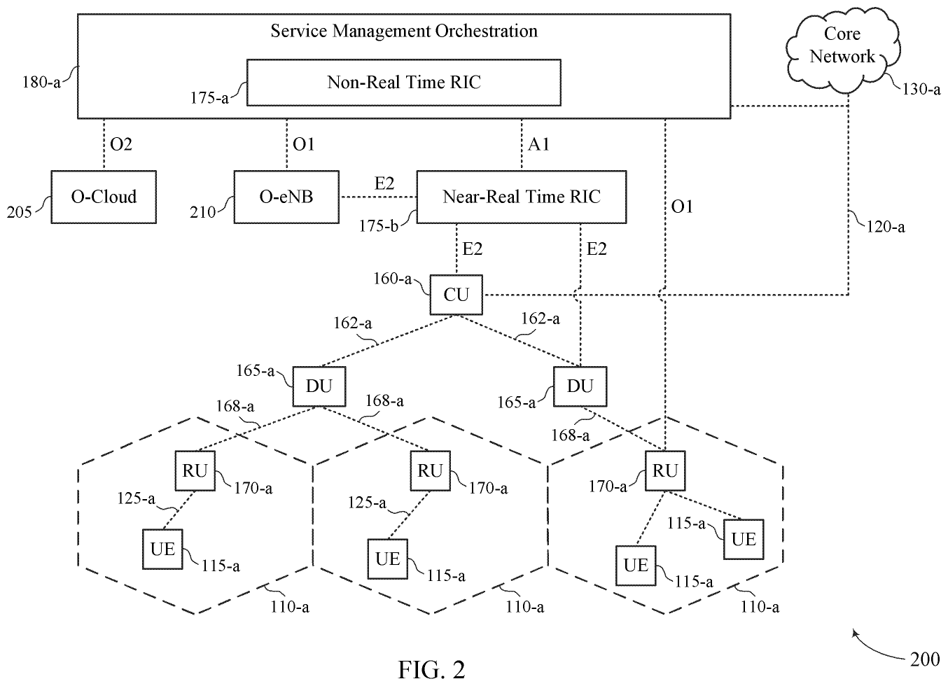

FIG. 2 illustrates an example of a network architecture 200 (e.g., a disaggregated base station architecture, a disaggregated RAN architecture) that supports techniques for managing power transfer and power saving in communication systems in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled with or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., Al policies).

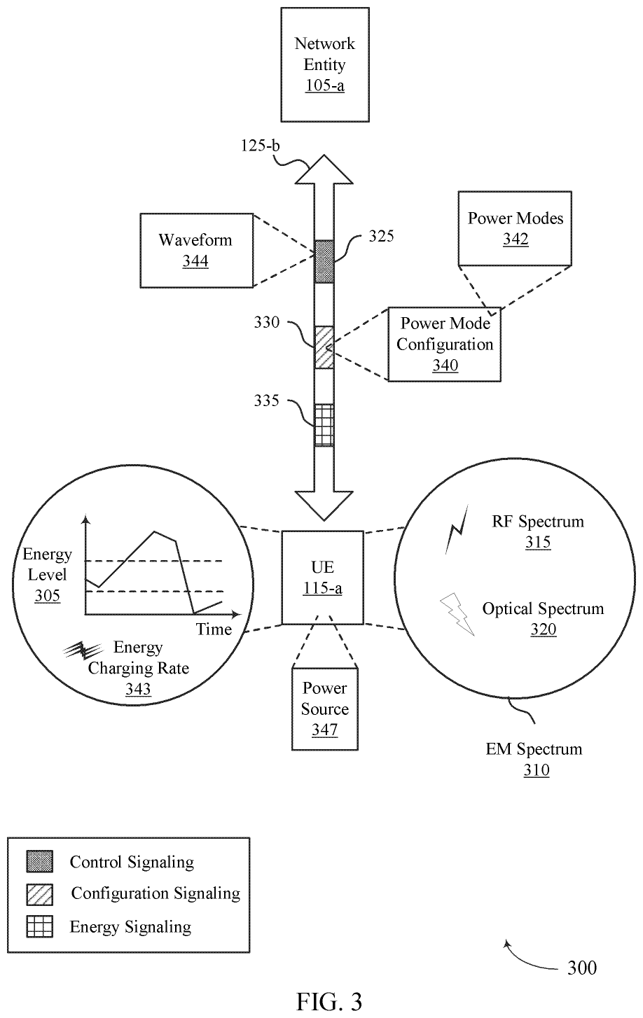

FIG. 3 illustrates an example of a wireless communications system 300 that supports techniques for managing power transfer, power saving, or both, in communication systems in accordance with one or more aspects of the present disclosure. The wireless communications system 300 may implement or be implemented by aspects of the wireless communications system 100. For example, the wireless communications system 300 may include a network entity 105-a and a UE 115-a, which may be examples of a network entity 105 (or other network entity) and a UE 115 as described with reference to FIG. 1. The network entity 105-a and the UE 115-a may communicate with one another via a communication link 125-b, which may be an example of a communication link 125 as described with reference to FIG. 1. The wireless communications system 300 may support multiple radio access technologies including 4G systems such as LTE systems, LTE-A systems, or LTE-A Pro systems, 5G systems, or other systems and radio technologies, including future systems and radio technologies not explicitly mentioned herein (e.g., 6G systems). The network entity 105-a may manage power transfer by configuring the UE 115-a with a power mode corresponding to power transfer supported or unsupported by the network entity 105-a. By managing power transfer, the network entity 105-a may manage power saving such that energy transfer to the UE 115-a is unsupported by the network entity or a reduced energy charging rate is used for energy harvesting operations at the UE 115-a during periods of low traffic conditions. Additionally or alternatively, the UE 115-a may manage power saving by refraining from monitoring for the energy signal while configured for the power mode corresponding to power transfer unsupported by the network entity 105-a, optimizing power resources at the UE 115-a.

The UE 115-a may perform energy harvesting operations in order to accumulate energy. That is, the UE may harvest energy from energy sources included in an EM spectrum 310 in the wireless communication system 300 to maintain or increase the energy level 305 of the UE 115-a and perform wireless operations (e.g., communicate with the network entity 105-a, communicate with other communication devices in the wireless communication system 300). In some examples, the UE 115-a may accumulate energy by receiving an EM wave in the EM spectrum 310. For example, the UE 115-a may accumulate energy by receiving the EM wave in an RF spectrum 315 of the EM spectrum 310. Additionally, or alternatively, the UE 115-a may accumulate energy by receiving the EM wave in an optical spectrum 320 of the EM spectrum 310. In some examples, the UE 115-a may accumulate energy from one or more other energy sources (e.g., solar energy, thermal energy, vibration energy, and the like). In the example of FIG. 3, one or more of the energy sources may be intermittently available to be accumulated by the UE 115-a. Thus, the UE 115-a may rely on a rechargeable power source 347 having the capability to harvest and store energy. In some cases, the availability of one or more of the energy sources of the EM spectrum 310 may be unpredictable in nature and an energy charging rate 343 for the UE 115-a may vary.

The UE 115-a and the network entity 105-a may perform energy-efficient communications, which may also be referred to as green communication, by using techniques to conserve energy while performing network operations. For example, the UE 115-a, the network entity 105-a, or both, may operate in one or multiple different modes of operation in order to save power and maintain network operation in the wireless communication system 300. In some examples, the UE 115-a may operate in a DRX mode, to reduce power consumption at the UE 115-a. That is, the UE 115-a may be configured to be active (e.g., during an ON duration) and inactive periodically over time when in the DRX mode. In other examples, the network entity 105-a operating in a low power mode may have a reduced number of antennas activated at the network entity 105-a to reduce power consumption at the network entity 105-a. In some other examples, the network entity 105-a operating in a low power mode may adapt the bandwidth of the energy signaling. In some aspects, the network entity 105-a may use techniques to conserve energy based on network conditions. For example, the network entity 105-a may reduce the number of antennas activated at the network entity 105-a if the network entity 105-a transitions from a period of high data traffic between the UE 115-a and the network entity 105-a.

In some examples, switching the power modes of operation for the UE 115-a, the network entity 105-a, or both, may impact RF energy transfer as well as data rate respective to data signaling between the UE 115-a and the network entity 105-a. For example, adapting the bandwidth for the energy signaling 335, adapting the quantity of active antennas at the network entity 105-a, adjusting transmit power at the network entity 105-a, adjusting the quantity of multiple transmission and reception points (mTRPs), adjusting the quantity of relays supporting coverage, or a combination thereof may impact the RF energy transfer from the network entity 105-a to the UE 115-a. Additionally or alternatively, adapting the bandwidth for the energy signaling 335, adapting the number of active antennas at the network entity 105-a, adjusting transmit power at the network entity 105-a, adjusting the quantity of multiple transmission and reception points (mTRPs), adjusting the quantity of relays supporting coverage, or a combination thereof may impact the data rate. Additionally or alternatively, generating the power for EM waves in the optical spectrum 320 may require a large amount of energy. The network entity 105-a may need a technique for optimally transferring the energy signaling 335 such that generation of the EM waves in the optical spectrum 320 for energy transfer to the UE 115-a may be reduced, reducing the power consumption at the network entity 105-a.

In some cases, the network entity 105-a may be conflicted between transferring energy to be harvested by the UE 115-a and conserving energy at the network entity 105-a. For example, the network entity 105-a may support energy harvesting operations which may occur at the UE 115-a by transmitting the energy signaling 335 to the UE 115-a. In some aspects, the energy transfer performed by the UE 115-a may include RF energy transfer from the RF spectrum 315. In other aspects, the energy transfer performed by the network entity 105-a may include laser or light energy transfer from the optical spectrum 320. In such other aspects, the network entity 105-a may be a light power base station. By transferring the energy signaling 335 to the UE 115-a, the network entity 105-a may lose energy. Because the network entity 105-a may lose energy by transferring the energy signaling 335 to the UE 115-a, the network entity 105-a may have difficulty meeting green communication targets. For instance, in one or more examples, the network entity 105-a may have difficulty meeting power efficiency targets, low energy benchmarks, or other green communication targets due to energy lost at the network entity 105-a from transferring the energy signaling 335 to the UE 115-a.

The present disclosure provides techniques for enabling the UE 115-a and the network entity 105-a to support the exchange of signaling related to techniques for managing power transfer, power saving, or both in communication systems in accordance with one or more aspects of the present disclosure. As described herein, the energy harvesting device may be a communication device, such as the UE 115-a, in the wireless communications system 300 that has the capability to perform energy harvesting operations by capturing energy from external sources and converting the captured energy into stored energy which may be used by the communication device for wireless communication as described herein. The network entity 105-a may transmit the energy signaling 335 to the UE 115-a based on configuring the UE 115-a with a power mode of a set of power modes 342. The power mode configured for the UE 115-a may correspond to an energy transfer that is supported by the network entity 105-a. Additionally or alternatively, the power mode configured for the UE 115-a may correspond to an energy charging rate 343 associated with the energy transfer. Alternatively, the power mode configured for the UE 115-a may correspond to an energy transfer that is unsupported by the network entity 105-a.

In some aspects, the UE 115-a may disable or enable charging a power source 347 associated with the UE 115-a within a specific network power mode, such as the power mode configured for the UE 115-a. If the UE 115-a disables charging of the power source 347 of the UE 115-a, the UE 115-a may no longer charge the power source 347 of the UE 115-a. For example, if charging of the UE 115-a has been disabled, wireless charging may be unsupported even if the network entity 105-a configures the UE 115-a with a power mode corresponding to supported energy transfer and configures the UE 115-a with information that would allow for wireless charging to occur. Accordingly, when the charging of the UE 115-a is disabled, the UE 115-a may terminate reception of the energy signaling 335, energy harvesting from the energy signaling 335, charging of the power source 347 of UE 115-a, or a combination thereof. Alternatively, if the UE 115-a enables charging of the power source 347 of the power source 347, the UE 115-a may charge the power source 347 associated with the UE 115-a. For example, if charging of the UE 115-a is enabled, the UE 115-a may receive the energy signaling 335, harvest energy from the energy signaling 335, and charge the power source 347 of the UE 115-a, allowing for wireless charging at the UE 115-a.

In some examples, the UE 115-a may charge the power source 347 associated with the UE 115-a based on receiving a control signal. For example, the UE 115-a may receive a control signaling 325 from the network entity 105-a, and the control signaling 325 may enable or disable the charging of the power source 347 associated with the UE 115-a. In some aspects, the control signaling 325 may be a downlink control information (DCI) that indicates a waveform 344 associated with the power mode. In such aspects, the control signaling 325 may activate the waveform 344 associated with the power mode. In other such aspects, the control signaling 325 may deactivate the waveform 344 associated with the power mode. In some aspects, the control signaling 325 may be a MAC-CE signaling. In such aspects, the UE 115-a may receive a MAC-CE that indicates the waveform 344 associated with the power mode. In some examples, the MAC-CE may activate the waveform 344 associated with the power mode. In other examples, the MAC-CE may deactivate the waveform 344 associated with the power mode. In some examples, the control signaling 325 may be an RRC message that indicates the waveform 344 associated with the power mode.

In some examples, the control signaling 325 may be a layer-1 (L1) signal, a layer-2 (L2) signal, or a layer-3 (L3) signal. That is, the control signaling 325 may be associated with a signal that may be received at a specific layer of the UE 115-a. For instance, if the control signaling 325 is an L1 signal, the control signaling 325 may be received at a physical layer of the UE 115-a. If the control signaling 325 is an L2 signal, the control signaling 325 may be received at a data link layer of the UE 115-a. If the control signaling 325 is an L3 signal, the control signaling 325 may be received at a network layer of the UE 115-a. In some aspects, the UE 115-a may enable the associated power source 347 based on the control signaling 325 received at various layers. That is, if the control signaling 325 is a type of layer signaling, the UE 115-a may enable or disable the charging of the associated power source 347 based on receiving the control signaling 325. If the UE 115-a receives the control signaling 325 that disables the charging of the power source 347 associated with the UE 115-a, the UE 115-a may terminate the charging of the power source 347 associated with the UE 115-a. Additionally of alternatively, if the UE 115-a receives the control signaling 325 that enables the charging of the power source 347 associated with the UE 115-a, the UE 115-a may charge the power source 347 associated with the UE 115-a.

The UE 115-a may communicate with the network entity 105-a in accordance with an uplink waveform, a downlink waveform, or both. Additionally, the waveform 344 associated with the power mode of the UE 115-a may correspond to the uplink waveform, the downlink waveform, or both. Put another way, the waveform 344 may be a data waveform for transmitting data, to the network entity 105-a, or receiving data from the network entity 105-a.

In some examples, the UE 115-a may communicate with one or more UE 115s in the wireless communications system 300 using the uplink waveform, the downlink waveform, or both, associated with the power mode of the UE 115-a. For instance, the UE 115-a may contain a sidelink control unit or a programmable logic controller (PLC), constituting a device similar to the network entity 105-a. The UE 115-a may perform sidelink communications using the sidelink control unit or the PLC. In some examples, the UE 115-a may send control signaling to a second UE 115 to indicate that the power mode of the UE 115-a may be associated with an uplink or downlink waveform. In such examples, the UE 115-a may communicate with the second UE 115 via the uplink or downlink waveform based on the control signaling from the UE 115-a. As such, the UE 115-a may transmit or receive data or energy signaling from the one or more other UE 115s via the uplink or downlink waveform.

In some examples, the UE 115-a may receive control signaling 325 that indicates the waveform 344 associated with the power mode, where the waveform 344 corresponds to an uplink waveform, a downlink waveform, or both. Based on receiving the control signaling 325 indicating the waveform 344 associated with the power mode to be an uplink waveform, a downlink waveform, or both, the UE 115-a may communicate with network entity 105-a accordingly. For example, if the control signaling 325 indicates that the power mode of the UE 115-a may be associated with an uplink waveform, the UE 115-a may communicate with the network entity 105-a via an uplink waveform. Additionally, or alternatively, if the control signaling 325 indicates that the power mode of the UE 115-a may be associated with a downlink waveform, the UE 115-a may communicate with the network entity 105-a via a downlink waveform. Additionally, or alternatively, if the control signaling 325 indicates that the power mode of the UE 115-a may be associated with both an uplink waveform and a downlink waveform, the UE 115-a may communicate with the network entity 105-a via an uplink waveform and a downlink waveform. Based on receiving the control signaling 325 and the power mode, the UE 115-a may select the waveform 344 from a set of waveforms. The set of waveforms may include an uplink waveform and a downlink waveform.

In some aspects, the UE 115-a may be preconfigured with a power mode that may either allow for or not allow for charging such that layer signaling may not change the enablement or disablement of charging. That is, the UE 115-a may charge the power source 347 associated with the UE 115-a irrespective of one or more of a L1 signal, a L2 signal, or a L3 signal (e.g., a layer associated with the control signaling 325) enabling or disabling the charging of the power source 347. For example, in some aspects, the UE 115-a may be preconfigured with a specific power mode that is associated with a charging feature, allowing for the UE 115-a to charge the associated power source 347. In such aspects, the UE 115-a may charge the associated power source 347 regardless of a L1 signal, a L2 signal, or a L3 signal.

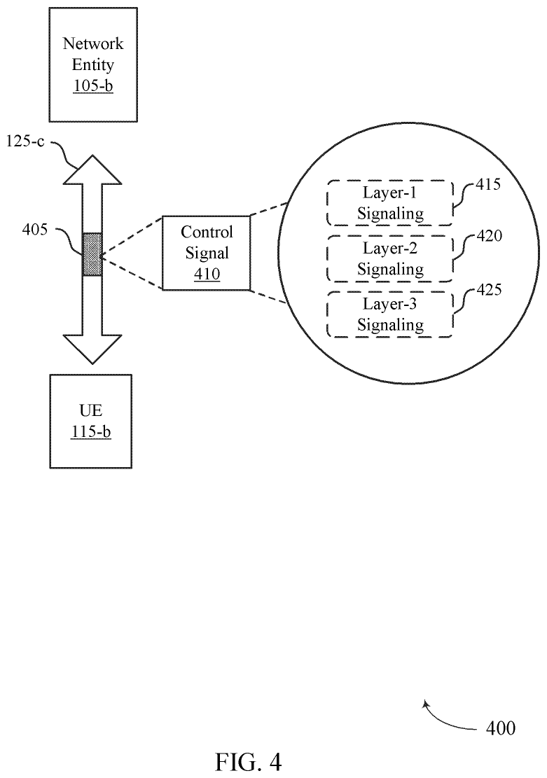

In some examples, the waveform 344 may be associated with the energy signaling 335 and may be a narrowband waveform or a broadband waveform as described with reference to FIG. 4. Broadband waveforms may support higher data rate transmissions than narrowband waveforms. If the energy signaling 325 is a narrowband waveform, the UE 115-a, the network entity 105-a, or both may cancel interference of the energy signaling 335 with small complexity. Whether the energy signaling 325 is a narrowband waveform or a broadband waveform, the network entity 105-a may beamform the energy signaling 325 with minimal difficulties. In some examples, the network entity 105-a may beamform narrowband waveforms more easily than broadband waveforms because of the increased bandwidth associated with broadband waveforms.

Different waveforms may correspond to different frequencies. Additionally or alternatively, different waveforms may correspond to different wireless charging rates. For examples, multi-tone waveforms may have higher charging rates than single-tone waveforms due to the design of an energy harvesting circuit of the UE 115-a. The multi-tone waveforms may provide induced energy to diodes better than single-tone waveforms, causing the multi-tone waveforms to achieve higher charging rates. The mutli-tone waveforms may also enhance excitement of diodes because multi-tone waveforms may send bursts of energy the diodes, also contributing to higher charging rates.

The UE 115-a may charge the power source 347 associated with the UE 115-a based on receiving a configuration signaling 330. The configuration signaling 330 may include a power mode configuration 340 identifying a power mode of a set of power modes 342. A waveform of the energy signaling 335 may correspond to an energy charging rate 343. In some aspects, the network entity 105-a may configure the UE 115-a with a power mode and adjust the waveform for energy harvesting performed by the UE 115-a based on the power mode. In such aspects, the received energy signal (e.g., the energy signaling 335) may correspond to a beamformed energy signal of the waveform for the power mode.

For example, the network entity 105-a may configure the UE 115-a with a power mode by sending the configuration signaling 330 indicating the power mode, and the UE 115-a may support certain energy transfer waveforms for energy harvesting based on the power mode. In such cases, charging of the power source 347 associated with the UE 115-a may be based on the configuration 325. For instance, the UE 115-a may receive the configuration signaling 330, and the UE 115-a may be configured for the power mode based on the configuration signaling 330. The configured power mode may support an energy transfer waveform in accordance with the bandwidth of the waveform, the frequency of the waveform, or some other waveform characteristic (e.g., multi-tone vs. single-tone). The energy signaling 335 may correspond to a waveform that is supported or unsupported by the power mode configured for the UE 115-a.

Based on the power mode configuration 340, the UE 115-a may determine a waveform for the power mode. Because the determined waveform may correspond to an energy charging rate 343, the rate at which the charging of the power source 347 occurs may be based on the determined waveform. If the waveform of the energy signaling 335 corresponds to the determined waveform, then the UE 115-a may charge the power source 347 associated with the UE 115-a. Additionally or alternatively, if the waveform of the energy signaling 335 does not correspond to the determined waveform, then the UE 115-a may not charge the power source 347 using the energy signaling 335. The network entity 105-a may be aware of the waveform corresponding to the energy signaling 335. Therefore, the network entity 105-a may configure the UE 115-a with a power mode such that the UE 115-a may or may not support energy harvesting based on the energy signaling 335. Additionally, the network entity 105-a may configure the UE 115-a with a power mode such that the UE 115-a may support energy harvesting with a specific energy charging rate 343.

In some implementations, the UE 115-a, the network entity 105-a, or both, may scheduling a charging session, which may be defined as a time duration during which the UE 115-a may charge the power source 347 of the UE 115-a. The charging session may also be referred to as a charging time interval. In some examples, the UE 115-a may determine timing information to charge the power source 347 associated with the UE 115-a. The timing information may indicate a charging time interval for the charging of the power source 347 associated with the UE 115-a. The charging time interval may contain a beginning period and ending period.

In some aspects, the UE 115-a, the network entity 105-a, or both, may schedule the charging session dynamically. For instance, the UE 115-a may determine the charging time interval during communications with the network entity 105-a and in accordance with data traffic on the communication link 125-a. In other aspects, the UE 115-a, the network entity 105-a, or both may schedule the charging session periodically. In such aspects, the energy signaling 335 may be a periodic energy signal. The UE 115-a may perform a setup procedure that involves an exchange of signaling (e.g., signaling exchanged with the network entity 105-a. The UE 115-a may determine the timing information for the charging the power source 347 based on signaling during the setup procedure. Additionally, or alternatively, the UE 115-a may determine the timing information based on characteristics of the UE 115-a. The network entity 105-a, the UE 115-a, or both may determine parameters for the energy signaling 335 transferred in the charging time interval based on data traffic. For example, in low traffic periods (e.g., durations when the volume of data exchanged between the network entity 105-a and the UE 115-a is small), the network entity 105-a may configure the UE 115-a with a power mode for power saving that is associated with a reduced charging rate in order to conserve energy. Additionally, or alternatively, in high traffic periods (e.g., durations when the volume of data exchanged between the network entity 105-a and the UE 115-a is large), the network entity 105-a may configure the UE 115-a with a power mode that is associated with an increased charging rate.

In some examples, the UE 115-a may determine the timing information based on an RRC configuration. In such examples, the RRC configuration may configure the UE 115-a with a “start” time at the UE 115-a may start charging the power source 347 and a “stop” time at which the UE 115-a may terminate charging of the power source 347. In some examples, the UE 115-a may determine the timing information based on a MAC-CE. In such examples, the MAC-CE may activate or deactivate the charging of the power source 347 associated with the UE 115-a based on the timing information.

In some aspects, the UE 115-a may adapt the energy charging rate 343 for energy harvesting operations via an open loop approach. In other aspects, the UE 115-a may adept the energy charging rate 343 for energy harvesting operations via a closed-loop approach, where the UE 115-a may transmit feedback information to the network entity 105-a. The feedback information may indicate, from the perspective of the UE 115-a, a waveform 344 for the power mode, a frequency associated with the waveform 344, a set of spatial parameters, or a combination thereof. In some aspects, the feedback information may indicate a waveform 344 for the power mode, a frequency associated with the waveform 344, a set of spatial parameters, or a combination thereof that is preferred by the UE 115-a. The energy charging rate 343 for the power source 347 of the UE 115-a may be based on one or more portions of the feedback information. That is, the energy charging rate 343 for the power source 347 of the UE 115-a in the power mode may be based on the waveform 344 for the power mode, the frequency associated with the waveform 344, the set of spatial parameters, of a combination thereof.

The feedback information may be based on the layer at which the UE 115-a performs measurements to determine the feedback information. In some examples, the feedback information may contain L3 feedback that is based on L3 measurements. In such examples, the UE 115-a may be configured with defined measurement gaps. The configured measurement gaps may be defined time durations during which the UE 115-a may perform channel measurements. The UE 115-a may perform the L3 measurements based on the measurement gaps. In some examples, the UE 115-a may measure the charging rate for the power source 347 during the configured measurement gaps. In other examples, the feedback information may contain L1 feedback that is based on L1 measurement. In such other examples, the L1 feedback may include a channel quality indicator (CQI) to indicate the quality of received communications on the channel.

FIG. 4 illustrates an example of a wireless communications system 400 that supports techniques for managing power transfer and power saving in communication systems in accordance with one or more aspects of the present disclosure. The wireless communications system 400 may implement or be implemented by aspects of the wireless communications system 100 as described with reference to FIG. 1. For example, the wireless communications system 400 may include a network entity 105-b and a UE 115-b, which may be examples of a network entity 105 (or other network entity) and a UE 115 as described with reference to FIG. 1. The network entity 105-b and the UE 115-b may communicate with one another via a communication link 125-c, which may be an example of a communication link 125 as described with reference to FIG. 1. Additionally, or alternatively, the wireless communications system 400 may implement or be implemented by aspects of the network architecture 200 as described with reference to FIG. 2. The wireless communications system 400 may be an LTE network, an LTE-A network, an LTE-A Pro network, an NR network, or a network operating in accordance with other systems and radio technologies, including future systems and radio technologies not explicitly mentioned herein.

In the example of FIG. 4, the network entity 105-b may configure the UE 115-b with information that indicates whether a charging operation is allowed or not allowed. For example, the UE 115-b may be configured with information that indicates that wireless charging is allowed or not allowed. When the wireless charging is allowed, the network entity 105-b may enable or disable the wireless charging for the UE 115-b via signaling 405. The network entity 105-b may output (or transmit), and the UE 115-b may receive, a control signal 410, which may enable or disable a charging operation at the UE 115-b. In some examples, the network entity 105-b enable or disable charging operation at the UE 115-b based on L1 signaling 415. For example, the UE 115-b may enable charging the power source associated with the UE 115-b by receiving an L1 signal via lower protocol layers (e.g., PHY layer). Alternatively, the UE 115-b may disable charging the power source associated with the UE 115-b by receiving an L1 signal via lower protocol layers (e.g., PHY layer).

In some other examples, the network entity 105-b enable or disable charging operation at the UE 115-b based on L2 signaling 420. For example, the UE 115-b may enable charging the power source associated with the UE 115-b by receiving an L2 signal via upper protocol layers (e.g., MAC, RLC, PDCP). Alternatively, the UE 115-b may disable charging the power source associated with the UE 115-b by receiving an L2 signal via upper protocol layers (e.g., MAC, RLC, PDCP). In other examples, the network entity 105-b enable or disable charging operation at the UE 115-b based on L3 signaling 425. For example, the UE 115-b may enable charging the power source associated with the UE 115-b by receiving an L3 signal via upper protocol layers (e.g., RRC). Alternatively, the UE 115-b may disable charging the power source associated with the UE 115-b by receiving an L3 signal via upper protocol layers (e.g., RRC).

Alternatively, the charging operation may be preconfigured or configured and cannot be changed by control signaling. For example, a power mode (e.g., a deep sleep mode), the network entity 105-b might not transfer wireless energy to the UE 115-b. In some examples, a power mode may be configured or preconfigured at the one or both of the network entity 105-b or the UE 115-b and may be irrespective of any control signaling from the network entity 105-b. Put another way, the network entity 105-b may be unable to change whether a charging operation is allowed or not allowed at one or both of the network entity 105-b or the UE 115-b.

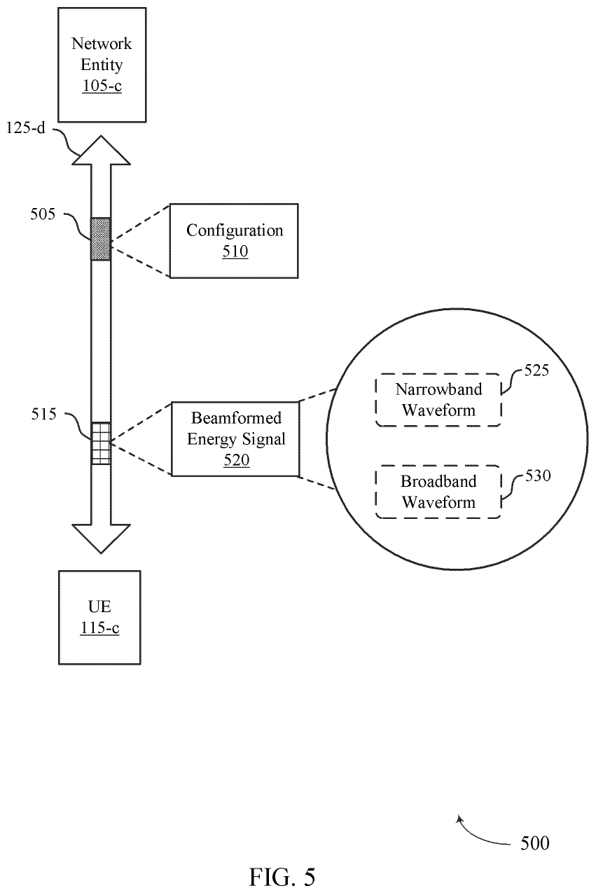

FIG. 5 illustrates an example of a wireless communications system 500 that supports techniques for managing power transfer and power saving in communication systems in accordance with one or more aspects of the present disclosure. The wireless communications system 500 may implement or be implemented by aspects of the wireless communications system 100 as described with reference to FIG. 1. For example, the wireless communications system 500 may include a network entity 105-c and a UE 115-c, which may be examples of a network entity 105 (or other network entity) and a UE 115 as described with reference to FIG. 1. The network entity 105-c and the UE 115-c may communicate with one another via a communication link 125-d, which may be an example of a communication link 125 as described with reference to FIG. 1. Additionally, or alternatively, the wireless communications system 500 may implement or be implemented by aspects of the network architecture 200 as described with reference to FIG. 2. The wireless communications system 500 may be an LTE network, an LTE-A network, an LTE-A Pro network, an NR network, or a network operating in accordance with other systems and radio technologies, including future systems and radio technologies not explicitly mentioned herein.

One or both of the network entity 105-c or the UE 115-c may support various waveforms for energy communication (e.g., energy transfer, energy harvesting). In some examples, a particular waveform may be supported by one or both of the network entity 105-c or the UE 115-c for a particular power mode. For example, a certain energy transfer waveform may be supported for a certain power mode (i.e., waveform of energy harvesting may change based on a particular power mode). In the example of FIG. 5, the network entity 105-c may output (or transmit), and the UE 115-c may receive, a control signal 505 that include a configuration 510. The configuration 510 may be associated with a power mode of a set of power modes. The power mode may correspond to an energy transfer supported by the network entity 105-c and an energy charging rate associated with the energy transfer.

One or both of the network entity 105-c or the UE 115-c may determine a waveform for the power mode based on the configuration 510. The network entity 105-c may output (or transmit), and the UE 115-c may receive, signaling 515, such as a beamformed energy signal 520, which may correspond to the waveform. In some examples, the waveform may be a narrowband waveform 525 or a broadband waveform 530. In some examples, the network entity 105-c may select a frequency of the beamformed energy signal 520 to maximize the energy charging rate associated with the energy transfer from the beamformed energy signal 520 at the UE 115-c.

In some examples, the network entity 105-c may transmit a charging session schedule for the UE 115-c based on the configuration 510. For example, the configuration 510 may be an RRC configuration and the UE 115-c may determine timing information (e.g., a start time and stop time) for charging a power source associated with the UE 115-c based on the RRC configuration. In some other examples, the network entity 105-c may activate or deactivate a charging operation at the UE 115-c based on a MAC-CE. For example, the network entity 105-c may output (or transmit), and the UE 115-c may receive, a MAC-CE that may activate or deactivate the charging operation at the UE 115-c (e.g., charging a power source associated with the UE 115-c).

In other examples, the UE 115-c may determine (e.g., via PHY layer operation) a charging time interval associated with a charging burst (e.g., charging a power source associated with the UE 115-c). In some cases, a duration of a charging burst may be determined based on signaling during a setup procedure (e.g., an RRC procedure between the network entity 105-c and the UE 115-c). Additionally, or alternatively, a charging burst may be dependent on one or both of the network entity 105-c or the UE 115-c characteristics, as well as parameters based on data traffic between the network entity 105-c and the UE 115-c.

One or both of the network entity 105-c or the UE 115-c may support adaptation of an energy charging rate associated with the beamformed energy signal 520. In some examples, one or both of the network entity 105-c or the UE 115-c may support adaptation of an energy charging rate based on an open-loop method (e.g., a fixed energy charging rate). In some other examples, one or both of the network entity 105-c or the UE 115-c may support adaptation of an energy charging rate based on a closed-loop method (e.g., based on feedback). In some cases, one or both of the network entity 105-c or the UE 115-c may support adaptation of an energy charging rate based on L3 feedback associated with L3 measurements (e.g., measurement gaps may be defined and configured for one or both of the network entity 105-c or the UE 115-c to measure the energy charging rate). In some other cases, one or both of the network entity 105-c or the UE 115-c may support adaptation of an energy charging rate based on L1 feedback, such as channel quality indicator (CQI). The energy charging rate may be dependent on a type of waveform used by one or both of the network entity 105-c or the UE 115-c. For example, the UE 115-c may transmit feedback information that indicates a waveform, a frequency associated with the waveform, or a set of spatial parameters, or a combination thereof. In some cases, one or both of the network entity 105-c or the UE 115-c may use reference signal for measurement whose waveform share the same characteristics of the beamformed energy signal 520.

One or both of the network entity 105-c or the UE 115-c may support canceling interference between the beamformed energy signal 520 and other signals in the wireless communications system 500 with low complexity based on the narrowband waveform 525 or the broadband waveform 530. In some examples, one or both of the network entity 105-c or the UE 115-c may support use of pseudorandom codes to randomize any possible interference between signals (e.g., the beamformed energy signal 520 and other signals) in the wireless communications system 500.

In the example of FIG. 5, one or both of the network entity 105-c or the UE 115-c may support various waveforms for wireless communication (e.g., downlink communication, uplink communication). In some examples, a particular waveform may be supported by one or both of the network entity 105-c or the UE 115-c for a particular power mode. For example, a certain waveform may be supported for a certain power mode. In some examples, the UE 115-c may be configured with a certain uplink waveform for a certain power mode. In some other examples, the UE 115-c may be configured with a certain downlink waveform for a certain power mode. In other examples, the UE 115-c may be configured with a certain uplink/downlink waveform for a certain power mode.

In some examples, the UE 115-c may be configured with multiple waveforms for multiple power modes, and the UE 115-c may receive from the network entity 105-c, an indication indicating which waveform among the multiple configured waveforms to use for a particular power mode. The network entity 105-c may indicate via an RRC message, a MAC-CE, or a DCI, or any combination thereof, a beginning time for when the UE 115-c may start using a certain waveform for a duration or until a new deactivation is received at the UE 115-c. In some cases, one or both of the network entity 105-c or the UE 115-c may support a switching time between power modes before the UE 115-c expects the network entity 105-c to switch between waveforms (e.g., from a first waveform to a second waveform). For example, the UE 115-c may determine an offset time interval for switching to a waveform based on the received configuration 510. In some examples, the switching time can be a function of the waveforms (e.g., the first waveform and the second waveform). In some examples, the switching time may be different based on the type of waveform (i.e., downlink waveform, uplink waveform).

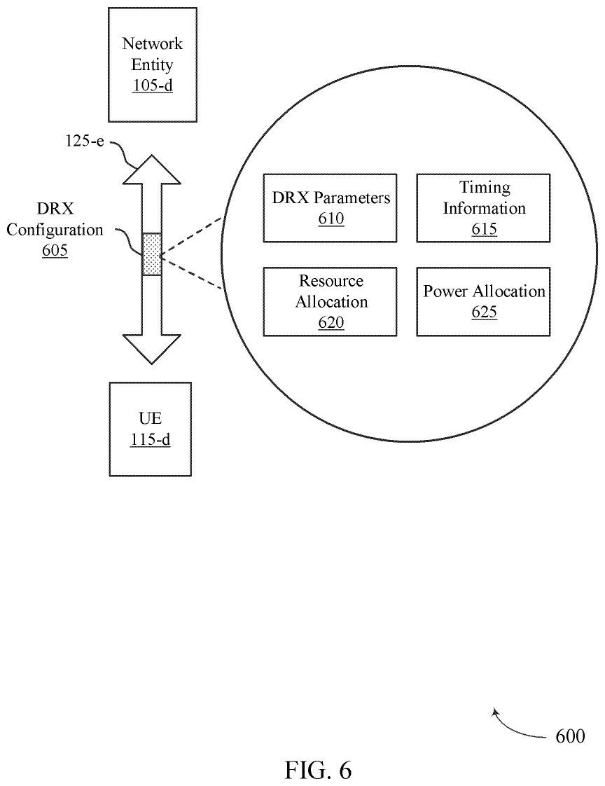

FIG. 6 illustrates an example of a wireless communications system 600 that supports techniques for managing power transfer and power saving in communication systems in accordance with one or more aspects of the present disclosure. The wireless communications system 600 may implement or be implemented by aspects of the wireless communications system 100 as described with reference to FIG. 1. For example, the wireless communications system 600 may include a network entity 105-d and a UE 115-d, which may be examples of a network entity 105 (or other network entity) and a UE 115 as described with reference to FIG. 1. The network entity 105-d and the UE 115-d may communicate with one another via a communication link 125-e, which may be an example of a communication link 125 as described with reference to FIG. 1. Additionally, or alternatively, the wireless communications system 600 may implement or be implemented by aspects of the network architecture 200 as described with reference to FIG. 2. The wireless communications system 600 may be an LTE network, an LTE-A network, an LTE-A Pro network, an NR network, or a network operating in accordance with other systems and radio technologies, including future systems and radio technologies not explicitly mentioned herein.

In the example of FIG. 6, the network entity 105-d may output (or transmit), and the UE 115-d may receive, a DRX configuration 605. The DRX configuration 605 may include one or more DRX parameters 610, timing information 615 recommended by the UE 115-d, a resource allocation 620 preferred by the UE 115-d, a power allocation 625 preferred by the UE 115-d, or a combination thereof. Put another way, the DRX configuration 605 may be dependent on time parameters suggested by the UE 115-d, resource recommendations provided by the UE 115-d, power allocation recommendations by the UE 115-d, etc. In some examples, the DRX configuration 605 may be based on a mode of one or both of the network entity 105-d or the UE 115-d. As such, based on the mode of one or both of the network entity 105-d or the UE 115-d one or more of the DRX parameters 610, the timing information 615 recommended by the UE 115-d, the resource allocation 620 preferred by the UE 115-d, the power allocation preferred by the UE 115-d, or a combination thereof may vary.

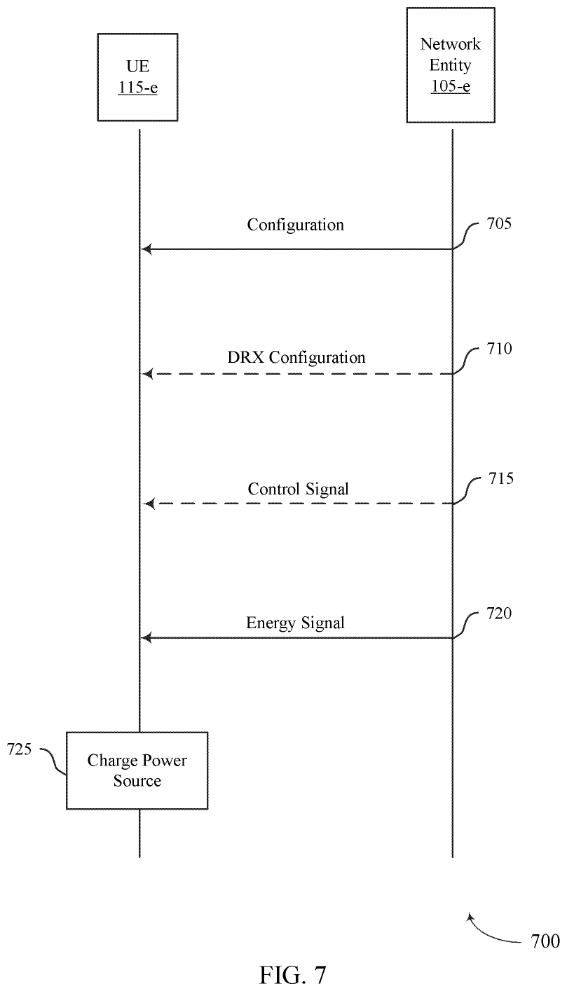

FIG. 7 illustrates an example of a process flow 700 that supports techniques for managing power transfer and power saving in communication systems in accordance with one or more aspects of the present disclosure. In some examples, the process flow 700 may implement or be implemented by aspects of the wireless communication system 100 as described with reference to FIG. 1. For example, the process flow 700 may be implemented by a network entity 105-e and a UE 115-e, which may be an example of a network entity 105 and a UE 115 as described with reference to FIG. 1. The process flow 700 may be implemented by the network entity 105-e and the UE 115-e to exchange signaling that promotes power saving at the network entity 105-e and power transfer to the UE 115-e. In the following description of the process flow 700, the operations between the network entity 105-e and the UE 115-e may be transmitted in a different order than the example order shown, or the operations performed by the network entity 105-e and the UE 115-e may be performed in different orders or at different times. Some operations may also be omitted from the process flow 700, and other operations may be added to the process flow 700.

At 705, the network entity 105-e may output (or transmit), and the UE 115-e may receive signaling indicating a configuration. For example, the UE 115-e may receive signaling indicating a configuration associated with a mode of a set of modes. The mode may correspond to a transfer supported by the network entity 105-e and a charging rate associated with the transfer. In some examples, a first subset of modes may correspond to transfer supported by the network entity 105-e, and a second subset of modes may correspond to transfer unsupported by the network entity 105-e. In some aspects, the mode may correspond to a type of the UE 115-e (e.g., type of energy harvesting circuit requirement, a transfer requirement, a charging rate requirement, or any combination thereof). The set of modes may include power modes, power saving modes, energy saving modes, communications modes, or a combination thereof. Additionally or alternatively, the first transfer may include a power transfer, an energy transfer, or both. Additionally or alternatively, the signal may include a power signal, an energy signal, or both. Additionally or alternatively, the charging rate may include a power charging rate, an energy charging rate, or both.

A mode corresponding to a transfer supported by the network entity 105-e may correspond to a waveform of a set of waveforms. The UE 115-e may determine a waveform for the mode based on the received configuration at 705. The determined waveform may be a narrowband waveform or a broadband waveform. A narrowband waveform may be defined as a signal or signals that occupy a narrow range of frequencies. A broadband wave may be defined as a signal or signals that occupy a wide range of frequencies. The determined waveform may correspond to the charging rate. In some aspects, the determined waveform may correspond to a frequency based on the charging rate. For example, the UE 115-e may select a frequency corresponding to the waveform for the mode such that the frequency may meets (e.g., maximizes) the charging rate associated with the transfer.

At 710, the network entity 105-e may output (or transmit), and the UE 115-e may receive, a DRX configuration. The DRX configuration may contain one or more DRX parameters associated with the mode, timing information recommended by the UE 115-e, a resource allocation preferred by the UE 115-e, a power allocation preferred by the UE 115-e, or a combination thereof. For example, the DRX configuration may define a DRX cycle, a DRX ON duration, a DRX OFF duration, and the like. The timing information recommended by the UE 115-e may correspond to one or more of the DRX cycle, the DRX ON duration, the DRX OFF duration, and the like. The resource allocation preferred by the UE 115-e may correspond to an amount of resources the UE 115-e may be requesting from the network entity 105-e for uplink communication, downlink communication, sidelink communication, or any combination thereof. The power allocation preferred by the UE 115-e may correspond to an amount of power transfer the UE 115-e may be requesting from the network entity 105-e to support normal operations at the UE 115-e, such as uplink communication, downlink communication, sidelink communication, or any combination thereof, or other processing operations at the UE 115-e associated with the uplink communication, the downlink communication, the sidelink communication, or any combination thereof.

At 715, the network entity 105-e may transmit (or output), and the UE 115-e may receive, a control signal. In some aspects, the control signal may enable or disable charging a source associated with the UE 115-e using protocol layer signaling. In such aspects, the control signal may include one or more of lower protocol layers, such as L1 (e.g., PHY layer) or upper protocol layer (e.g., L3, L2) functionality and signaling (e.g., RRC, SDAP, PDCP). For example, the UE 115-e may enable charging the source associated with the UE 115-e by receiving an L1 signal via lower protocol layers. Additionally, or alternatively, the UE 115-e may disable charging the source associated with the UE 115-e by receiving an L2 or L3 signal via upper protocol layers.

The UE 115-e may select the waveform for the mode based on the received control signaling and the mode associated with the waveform. The UE 115-e may select the waveform from a set of waveforms (e.g., a set of uplink waveforms, downlink waveforms, or a combination thereof) based on the received control signaling and the mode associated with the waveform. In some examples, the UE 115-e may receive the control signaling by receiving RRC signaling, a MAC-CE or a DCI. In some aspects, the network entity 105-e may output (or transmit), and the UE 115-e may receive, an RRC message that indicates the waveform associated with the mode. In some other aspects, the network entity 105-e may output (or transmit), and the UE 115-e may receive, a MAC-CE that indicates the waveform associated with the mode. The MAC-CE may include one or more MAC-CE elements that indicate to activate or deactivate the waveform associated with the mode. In some other aspects, the network entity 105-e may output (or transmit), and the UE 115-e may receive, a DCI that indicates the waveform associated with the mode. The DCI may include one or more DCI information elements (IEs) that may indicate to activate or deactivate the waveform associated with the mode. Thus, for each mode, the network entity 105-e may indicate through one or more of an RRC message, a MAC-CE or a DCI when to begin using a certain waveform for a duration or until a new deactivation is received through one or more of an RRC message, a MAC-CE or a DCI.

At 720, the network entity 105-e may output (or transmit), and the UE 115-e may receive, a signal based on the configuration indicated at 705. The signal may correspond to the transfer that corresponds to the mode associated with the configuration indicated at 705. In some examples, the signal may include an EM wave in an RF spectrum (e.g., an RF signal) or an optical spectrum (e.g., a light signal, a laser, or the like) of the EM spectrum. In some aspects, the signal received at 720 may be beamformed (e.g., transmission of a signal in a certain direction and orientation (e.g., angle). In such aspects, the signal may correspond to a beamformed signal of the waveform for the mode.

At 725, the UE 115-e may charge the source associated with the UE 115-e based on the signal received at 720, from the network entity 105-e, and in accordance with the charging rate associated with the transfer corresponding to the mode. In some examples, charging of the source associated with the UE 115-e may be based on the control signal received at 715. For example, the UE 115-e may charge the source associated with the UE 115-e based on receiving a control signal at 715 that enables charging of the source. Alternatively, the UE 115-e may terminate charging the source associated with the UE 115-e based on receiving a control signal at 715 that disables charging of the source. In some other examples, the mode may be preconfigured such that charging the source associated with the UE 115-e may be based on the configuration received at 705 and irrespective of one or more layer signals enabling or disabling charging the source.

In some aspects, charging the source associated with the UE 115-e may be based on a waveform determined for a mode. In some examples, timing information to charge the source associated with the UE 115-e may be determined based on a RRC configuration or a MAC-CE. The timing information to charge the source associated with the UE 115-e may be based on data traffic between the network entity 105-e and the UE 115-e. In such examples, the timing information may indicate a charging time including a beginning period and an ending period. Additionally, or alternatively, the MAC-CE may activate or deactivate charging the source associated with the UE 115-e.

By including or configuring the network entity 105-e and the UE 115-e in accordance with examples as described herein, the network entity 105-e may support techniques for better power saving and the UE 115-e may support techniques for longer battery life.

FIG. 8 shows a block diagram 800 of a device 805 that supports techniques for managing power transfer and power saving in communication systems in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for managing power transfer and power saving in communication systems). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for managing power transfer and power saving in communication systems). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for managing power transfer and power saving in communication systems as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at the device 805 (e.g., a UE) in accordance with examples as disclosed herein. For example, the communications manager 820 may be configured as or otherwise support a means for receiving, from a network entity, signaling indicating a configuration associated with a first mode of a set of modes, the first mode corresponding to a first transfer supported by the network entity and a first charging rate associated with the first transfer. The communications manager 820 may be configured as or otherwise support a means for receiving, from the network entity, a signal based on the indicated configuration, where the signal corresponds to the first transfer. The communications manager 820 may be configured as or otherwise support a means for charging a source associated with the UE based on the received signal and in accordance with the first charging rate associated with the first transfer.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for better power saving and longer battery life.

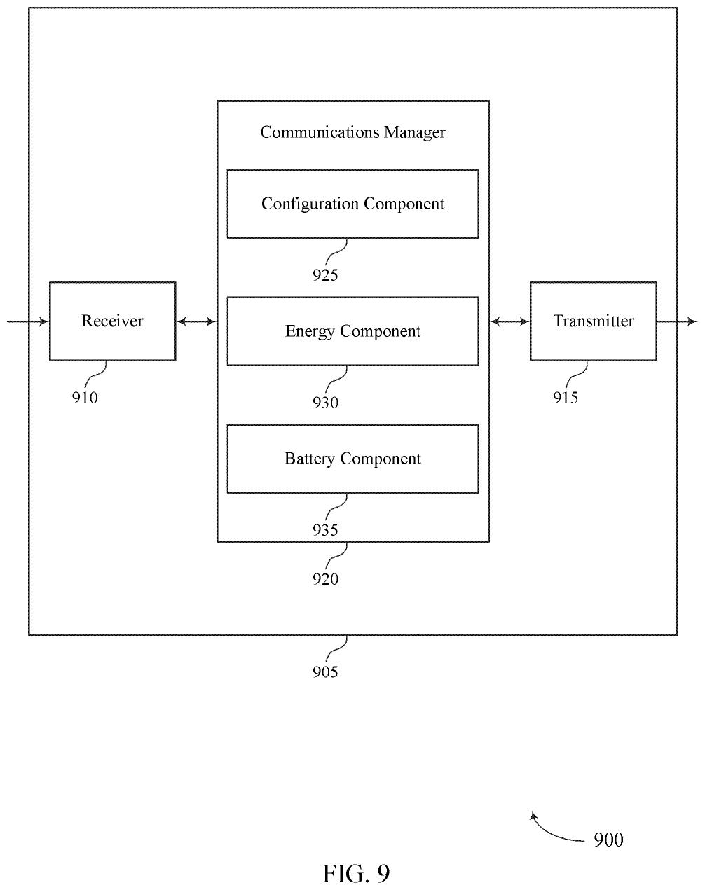

FIG. 9 shows a block diagram 900 of a device 905 that supports techniques for managing power transfer and power saving in communication systems in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for managing power transfer and power saving in communication systems). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for managing power transfer and power saving in communication systems). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for managing power transfer and power saving in communication systems as described herein. For example, the communications manager 920 may include a configuration component 925, an energy component 930, a battery component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at the device 905 (e.g., a UE) in accordance with examples as disclosed herein. The configuration component 925 may be configured as or otherwise support a means for receiving, from a network entity, signaling indicating a configuration associated with a first mode of a set of modes, the first mode corresponding to a first transfer supported by the network entity and a first charging rate associated with the first transfer. The energy component 930 may be configured as or otherwise support a means for receiving, from the network entity, a signal based on the indicated configuration, where the signal corresponds to the first transfer. The battery component 935 may be configured as or otherwise support a means for charging a source associated with the UE based on the received signal and in accordance with the first charging rate associated with the first transfer.

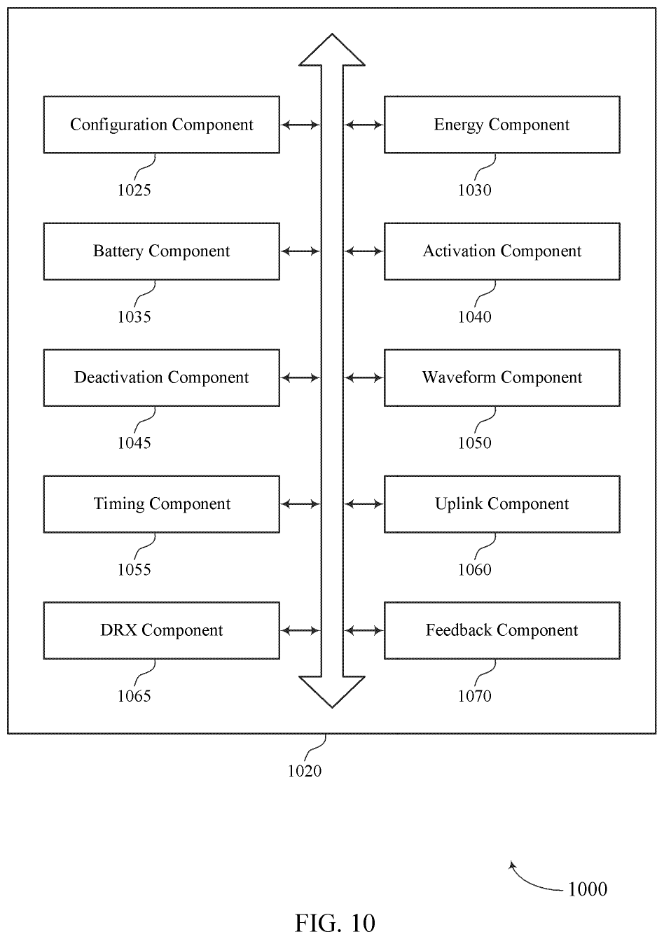

FIG. 10 shows a block diagram 1000 of a communications manager 1020 that supports techniques for managing power transfer and power saving in communication systems in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for managing power transfer and power saving in communication systems as described herein. For example, the communications manager 1020 may include a configuration component 1025, an energy component 1030, a battery component 1035, an activation component 1040, a deactivation component 1045, a waveform component 1050, a timing component 1055, an uplink component 1060, a DRX component 1065, a feedback component 1070, or any combination thereof. Each of these components may communicate, directly or indirectly, with one another (e.g., via one or more buses).

The communications manager 1020 may support wireless communication at a UE in accordance with examples as disclosed herein. The configuration component 1025 may be configured as or otherwise support a means for receiving, from a network entity, signaling indicating a configuration associated with a first mode of a set of modes, the first mode corresponding to a first transfer supported by the network entity and a first charging rate associated with the first transfer. In some examples, the set of modes may include power modes, power saving modes, energy saving modes, communications modes, or a combination thereof. Additionally or alternatively, the first transfer may include a power transfer, an energy transfer, or both. Additionally or alternatively, the signal may include a power signal, an energy signal, or both. Additionally or alternatively, the charging rate may include a power charging rate, an energy charging rate, or both. The energy component 1030 may be configured as or otherwise support a means for receiving, from the network entity, a signal based on the indicated configuration, where the signal corresponds to the first transfer. The battery component 1035 may be configured as or otherwise support a means for charging a source associated with the UE based on the received signal and in accordance with the first charging rate associated with the first transfer.

In some examples, the activation component 1040 may be configured as or otherwise support a means for receiving a control signal that enables charging the source associated with the UE, the control signal includes one or more of a L1 signal, a L2 signal, or a L3 signal. In some examples, the battery component 1035 may be configured as or otherwise support a means for charging of the source associated with the UE based on the received control signal. In some examples, the deactivation component 1045 may be configured as or otherwise support a means for receiving a control signal that disables charging the source associated with the UE, the control signal includes one or more of a L1 signal, a L2 signal, or a L3 signal. In some examples, the battery component 1035 may be configured as or otherwise support a means for terminating charging the source associated with the UE based on the received control signal. In some examples, charging of the source associated with the UE is based on the configuration and irrespective of one or more of a L1 signal, a L2 signal, or a L3 signal enabling or disabling charging the source.

In some examples, the waveform component 1050 may be configured as or otherwise support a means for determining a first waveform for the first mode based on the configuration, the received signal corresponding to the determined first waveform, and the determined first waveform corresponds to the first charging rate. In some examples, the battery component 1035 may be configured as or otherwise support a means for charging of source associated with the UE based on the determined first waveform. In some examples, the determined first waveform includes a narrowband waveform or a broadband waveform. In some examples, the determined first waveform corresponds to a first frequency based on the first charging rate. In some examples, the received signal corresponds to a beamformed signal of the first waveform.

In some examples, the timing component 1055 may be configured as or otherwise support a means for determining timing information to charge the source associated with the UE based on a RRC configuration or a MAC-CE. In some examples, the timing information indicates a charging time interval for charging the source associated with the UE. In some examples, the charging time interval includes a beginning period and an ending period. In some examples, the MAC-CE activates or deactivates charging the source associated with the UE. In some examples, the timing information to charge the source associated with the UE is based on data traffic between the network entity and the UE.

In some examples, the feedback component 1070 may be configured as or otherwise support a means for transmitting feedback information that indicates a first waveform, a frequency associated with the first waveform, or a set of spatial parameters, or a combination thereof. In some examples, the first charging rate is based on the first waveform, the frequency associated with the first waveform, the set of spatial parameters, or a combination thereof.

In some examples, the waveform component 1050 may be configured as or otherwise support a means for receiving control signaling that indicates a first waveform associated with the first mode, where the first waveform corresponds to an uplink waveform, a downlink waveform, or both. In some examples, the uplink component 1060 may be configured as or otherwise support a means for communicating with the network entity in accordance with the uplink waveform, the downlink waveform, or both. In some examples, the waveform component 1050 may be configured as or otherwise support a means for selecting the first waveform from a set of waveforms based on the received control signaling and the first mode associated with the first waveform. In some examples, the timing component 1055 may be configured as or otherwise support a means for determining a time interval associated with use of the first waveform based on the received control signaling. In some examples, the uplink component 1060 may be configured as or otherwise support a means for communicating with the network entity based on the determined time interval associated with the use of the first waveform.

In some examples, to support receiving the control signaling, the waveform component 1050 may be configured as or otherwise support a means for receiving a RRC message that indicates the first waveform associated with the first mode. In some examples, to support receiving the control signaling, the waveform component 1050 may be configured as or otherwise support a means for receiving a MAC-CE that indicates the first waveform associated with the first mode, the MAC-CE activating or deactivating the first waveform associated with the first mode. In some examples, to support receiving the control signaling, the waveform component 1050 may be configured as or otherwise support a means for receiving a DCI that indicates the first waveform associated with the first mode, the DCI activating or deactivating the first waveform associated with the first mode.

In some examples, the timing component 1055 may be configured as or otherwise support a means for determining an offset time interval for switching to the first waveform based on the configuration, where the offset time interval is based on a type of the first waveform, the type of first waveform corresponding to downlink or uplink, or both. In some examples, the DRX component 1065 may be configured as or otherwise support a means for receiving, from the network entity, a DRX configuration including one or more DRX parameters associated with the first mode, timing information recommended by the UE, a resource allocation preferred by the UE, a power allocation preferred by the UE, or a combination thereof. In some examples, the energy component 1030 may be configured as or otherwise support a means for where receiving the signal is based on the received DRX configuration.

In some examples, the energy component 1030 may be configured as or otherwise support a means for accumulating energy based on the received signal. In some examples, the battery component 1035 may be configured as or otherwise support a means for where charging of the source associated with the UE is based on the accumulated energy. In some examples, the signal includes an EM wave in a RF spectrum or an optical spectrum of an EM spectrum. In some examples, the first mode corresponds to a type of UE. In some examples, the UE corresponds to the type of UE. In some examples, the type of UE corresponds to a type of energy harvesting circuit requirement, a transfer requirement, or a charging rate requirement, or any combination thereof. In some examples, each mode of the set of modes associated with the network entity corresponds to a first waveform of a set of waveforms. In some examples, a first subset of modes corresponds to transfer supported by the network entity and a second subset of modes corresponds to transfer unsupported by the network entity.

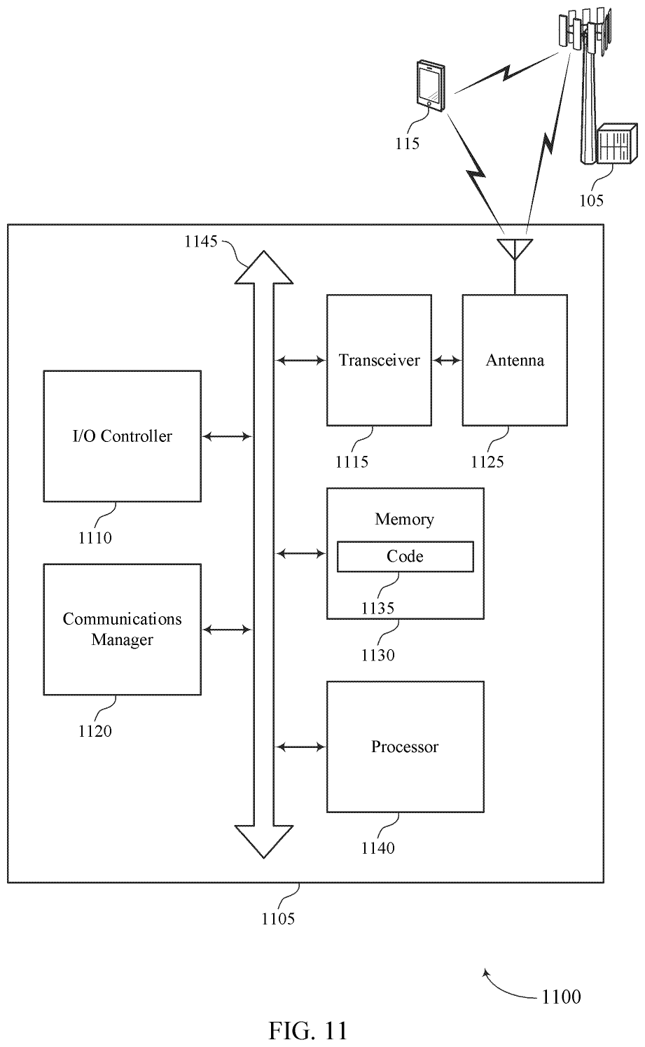

FIG. 11 shows a diagram of a system 1100 including a device 1105 that supports techniques for managing power transfer and power saving in communication systems in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROIDR, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for managing power transfer and power saving in communication systems). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at the device 1105 (e.g., a UE) in accordance with examples as disclosed herein. For example, the communications manager 1120 may be configured as or otherwise support a means for receiving, from a network entity, signaling indicating a configuration associated with a first mode of a set of modes, the first mode corresponding to a first transfer supported by the network entity and a first charging rate associated with the first transfer. The communications manager 1120 may be configured as or otherwise support a means for receiving, from the network entity, a signal based on the indicated configuration, where the signal corresponds to the first transfer. The communications manager 1120 may be configured as or otherwise support a means for charging a source associated with the UE based on the received signal and in accordance with the first charging rate associated with the first transfer.

By including or configuring the communications manager 1120 in accordance with examples as described herein, the device 1105 may support techniques for longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for managing power transfer and power saving in communication systems as described herein, or the processor 1140 and the memory 1130 may be otherwise configured to perform or support such operations.

FIG. 12 shows a block diagram 1200 of a device 1205 that supports techniques for managing power transfer and power saving in communication systems in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for managing power transfer and power saving in communication systems as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at the device 1205 (e.g., a network entity) in accordance with examples as disclosed herein. For example, the communications manager 1220 may be configured as or otherwise support a means for outputting signaling indicating a configuration associated with a first mode of a set of modes, the first mode corresponding to a first transfer supported by the network entity and a first charging rate associated with the first transfer. The communications manager 1220 may be configured as or otherwise support a means for outputting a signal based on the indicated configuration, where the signal corresponds to the first transfer.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced power consumption.

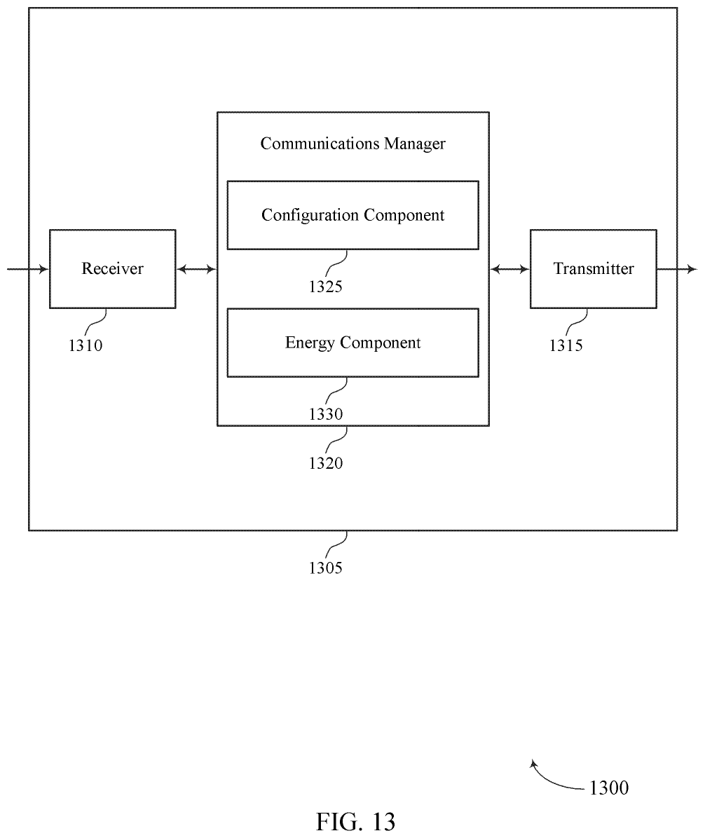

FIG. 13 shows a block diagram 1300 of a device 1305 that supports techniques for managing power transfer and power saving in communication systems in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for managing power transfer and power saving in communication systems as described herein. For example, the communications manager 1320 may include a configuration component 1325 an energy component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at the device 1305 (e.g., a network entity) in accordance with examples as disclosed herein. The configuration component 1325 may be configured as or otherwise support a means for outputting signaling indicating a configuration associated with a first mode of a set of modes, the first mode corresponding to a first transfer supported by the network entity and a first charging rate associated with the first transfer. The energy component 1330 may be configured as or otherwise support a means for outputting a signal based on the indicated configuration, where the signal corresponds to the first transfer.

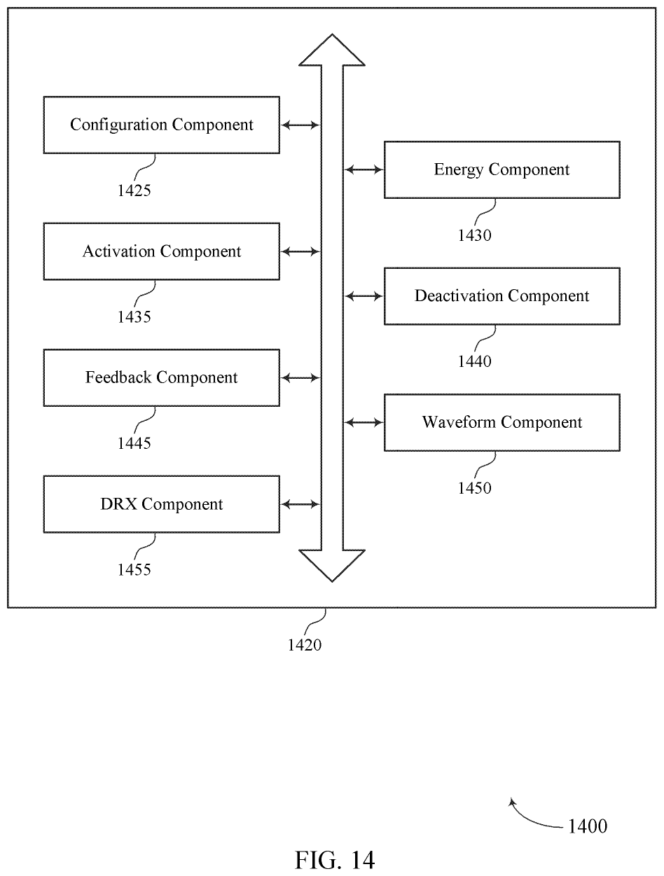

FIG. 14 shows a block diagram 1400 of a communications manager 1420 that supports techniques for managing power transfer and power saving in communication systems in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for managing power transfer and power saving in communication systems as described herein. For example, the communications manager 1420 may include a configuration component 1425, an energy component 1430, an activation component 1435, a deactivation component 1440, a feedback component 1445, a waveform component 1450, a DRX component 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The configuration component 1425 may be configured as or otherwise support a means for outputting signaling indicating a configuration associated with a first mode of a set of modes, the first mode corresponding to a first transfer supported by the network entity and a first charging rate associated with the first transfer. The energy component 1430 may be configured as or otherwise support a means for outputting a signal based on the indicated configuration, where the signal corresponds to the first transfer.

In some examples, each mode of the set of modes associated with the network entity corresponds to a first waveform of a set of waveforms. In some examples, a first subset of modes corresponds to transfer supported by the network entity and a second subset of modes corresponds to transfer unsupported by the network entity.

In some examples, the activation component 1435 may be configured as or otherwise support a means for transmitting a control signal that enables charging the source associated with a UE, the control signal includes one or more of a L1 signal, a L2 signal, or a L3 signal. In some examples, the deactivation component 1440 may be configured as or otherwise support a means for transmitting a control signal that disables charging the source associated with a UE, the control signal includes one or more of a L1 signal, a L2 signal, or a L3 signal.

In some examples, the feedback component 1445 may be configured as or otherwise support a means for receiving feedback information that indicates a first waveform, a frequency associated with the first waveform, or a set of spatial parameters, or a combination thereof. In some examples, the waveform component 1450 may be configured as or otherwise support a means for transmitting control signaling that indicates a first waveform associated with the first mode, where the first waveform corresponds to an uplink waveform, a downlink waveform, or both.

In some examples, the waveform component 1450 may be configured as or otherwise support a means for transmitting a RRC message that indicates the first waveform associated with the first mode. In some examples, the waveform component 1450 may be configured as or otherwise support a means for transmitting a MAC-CE that indicates the first waveform associated with the first mode, the MAC-CE activating or deactivating the first waveform associated with the first mode. In some examples, the waveform component 1450 may be configured as or otherwise support a means for transmitting a DCI that indicates the first waveform associated with the first mode, the DCI activating or deactivating the first waveform associated with the first mode.

In some examples, the DRX component 1455 may be configured as or otherwise support a means for transmitting a DRX configuration including one or more DRX parameters associated with the first mode, timing information recommended by a UE, a resource allocation preferred by the UE, a power allocation preferred by the UE, or a combination thereof.

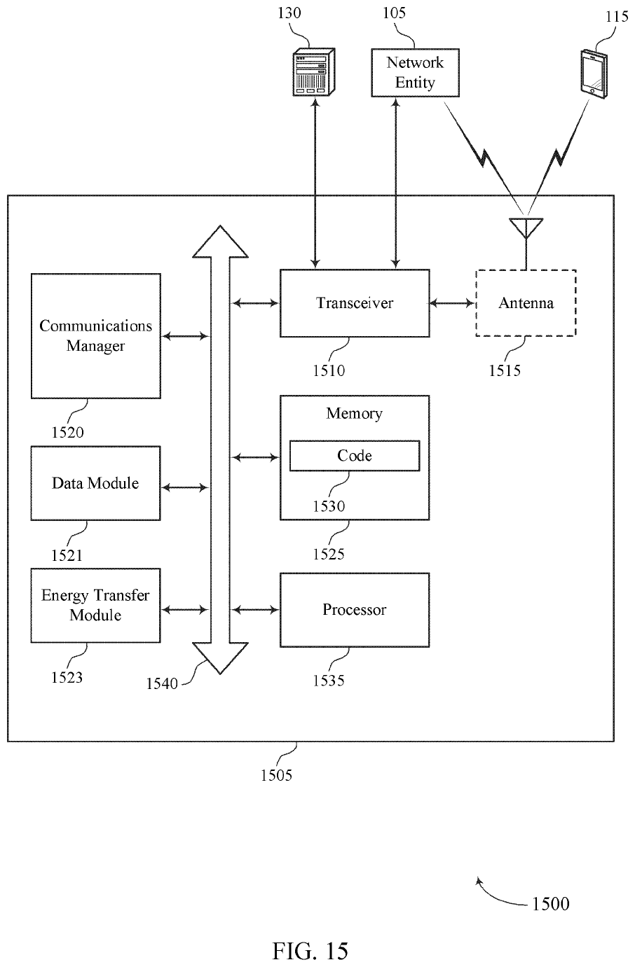

FIG. 15 shows a diagram of a system 1500 including a device 1505 that supports techniques for managing power transfer and power saving in communication systems in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a data module 1521, a transfer module 1523, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The data module 1521 may support wireless communication at the device 1505 (e.g., a network entity) in accordance with examples as disclosed herein. The transfer module 1523 may be circuitry that may support transfer operations. The circuitry may include one or multiple circuit elements, such as resistors, transistors, capacitors, inductors, amplifiers, diodes, among other examples, that may be coupled (e.g., operatively, communicatively, functionally, electronically, or electrically) with each other to support transfer operations at the device 1505. The circuitry may transmit energy (e.g., RF energy, light energy, etc.) as described herein.

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for managing power transfer and power saving in communication systems). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at the device 1505 (e.g., a network entity) in accordance with examples as disclosed herein. For example, the communications manager 1520 may be configured as or otherwise support a means for outputting signaling indicating a configuration associated with a first mode of a set of modes, the first mode corresponding to a first transfer supported by the network entity and a first charging rate associated with the first transfer. The communications manager 1520 may be configured as or otherwise support a means for outputting a signal based on the indicated configuration, where the signal corresponds to the first transfer.

By including or configuring the communications manager 1520 in accordance with examples as described herein, the device 1505 may support techniques for reduced power consumption.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of techniques for managing power transfer and power saving in communication systems as described herein, or the processor 1535 and the memory 1525 may be otherwise configured to perform or support such operations.

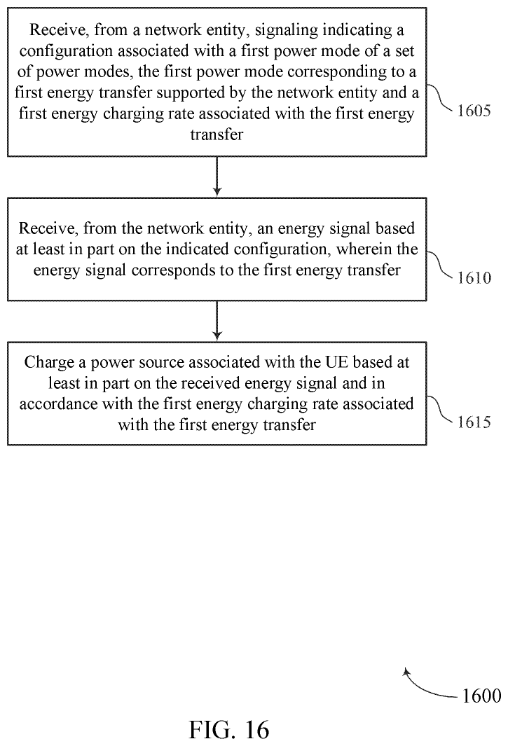

FIG. 16 shows a flowchart illustrating a method 1600 that supports techniques for managing power transfer and power saving in communication systems in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, signaling indicating a configuration associated with a first mode of a set of modes, the first mode corresponding to a first transfer supported by the network entity and a first charging rate associated with the first transfer. The operations of 1605 may be performed in accordance with examples as disclosed herein. In some examples, aspects of the operations of 1605 may be performed by a configuration component 1025 as described with reference to FIG. 10.

At 1610, the method may include receiving, from the network entity, a signal based on the indicated configuration, where the signal corresponds to the first transfer. The operations of 1610 may be performed in accordance with examples as disclosed herein. In some examples, aspects of the operations of 1610 may be performed by an energy component 1030 as described with reference to FIG. 10.

At 1615, the method may include charging a source associated with the UE based on the received signal and in accordance with the first charging rate associated with the first transfer. The operations of 1615 may be performed in accordance with examples as disclosed herein. In some examples, aspects of the operations of 1615 may be performed by a battery component 1035 as described with reference to FIG. 10.

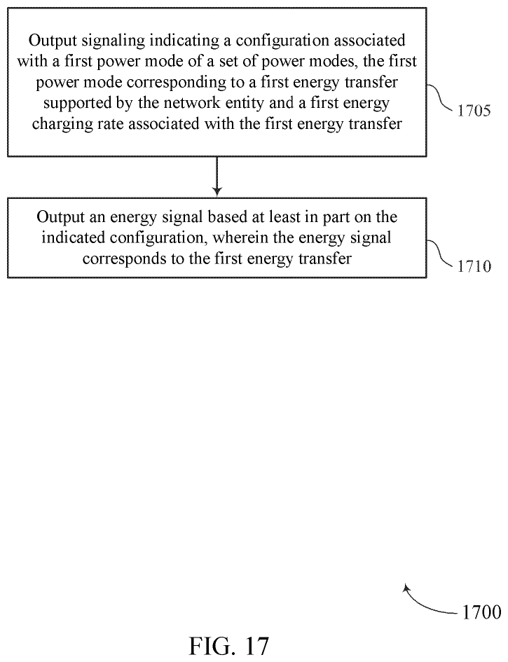

FIG. 17 shows a flowchart illustrating a method 1700 that supports techniques for managing power transfer and power saving in communication systems in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include outputting signaling indicating a configuration associated with a first mode of a set of modes, the first mode corresponding to a first transfer supported by the network entity and a first charging rate associated with the first transfer. The operations of 1705 may be performed in accordance with examples as disclosed herein. In some examples, aspects of the operations of 1705 may be performed by a configuration component 1425 as described with reference to FIG. 14.

At 1710, the method may include outputting a signal based on the indicated configuration, where the signal corresponds to the first transfer. The operations of 1710 may be performed in accordance with examples as disclosed herein. In some examples, aspects of the operations of 1710 may be performed by an energy component 1430 as described with reference to FIG. 14.

The following provides an overview of aspects of the present disclosure:

Aspect 1: An apparatus for wireless communication at a UE, comprising: a processor; memory coupled with the processor; and instructions stored in the memory and executable by the processor to cause the apparatus to: receive, from a network entity, signaling indicating a configuration associated with a respective mode of a set of modes, the respective mode corresponding to a respective transfer supported by the network entity and a respective charging rate associated with the respective transfer; receive, from the network entity, a signal based at least in part on the indicated configuration, wherein the signal corresponds to the respective transfer; and charge of a source associated with the UE based at least in part on the received signal and in accordance with the respective charging rate associated with the respective transfer.

Aspect 2: The apparatus of aspect 1, wherein the instructions are further executable by the processor to cause the apparatus to receive a control signal that enables the charging of the source associated with the UE, the control signal comprises one or more of a L1 signal, a L2 signal, or a L3 signal, wherein charging of the source associate with the UE is based at least in part on the received control signal.

Aspect 3: The apparatus of any of aspects 1 through 2, wherein the instructions are further executable by the processor to cause the apparatus to receive a control signal that disables the charging of the source associated with the UE, the control signal comprises one or more of a L1 signal, a L2 signal, or a L3 signal; and terminate the charging of the source associated with the UE based at least in part on the received control signal.

Aspect 4: The apparatus of any of aspects 1 through 3, wherein charging of the source associated with the UE is based at least in part on the configuration and irrespective of one or more of a L1 signal, a L2 signal, or a L3 signal enabling or disabling the charging of the source.

Aspect 5: The apparatus of any of aspect 1, wherein the set of modes comprises power modes, power saving modes, energy saving modes, communications modes, or a combination thereof, wherein the first transfer comprises a power transfer, an energy transfer, or both, wherein the signal comprises a power signal, an energy signal, or both, and wherein the charging rate comprises a power charging rate, an energy charging rate, or both.

Aspect 6: The apparatus of any of aspects 1 through 4, wherein the instructions are further executable by the processor to cause the apparatus to determine a respective waveform for the respective mode based at least in part on the received configuration, the received signal corresponds to the determined respective waveform, and the determined respective waveform corresponds to the respective charging rate, wherein charging of source associate with the UE is based at least in part on the determined respective waveform.

Aspect 7: The apparatus of aspect 6, wherein the determined respective waveform comprises a narrowband waveform or a broadband waveform.

Aspect 8: The apparatus of any of aspects 6 through 7, wherein the determined respective waveform corresponds to a respective frequency based at least in part on the respective charging rate.

Aspect 9: The apparatus of any of aspects 6 through 8, wherein the received signal corresponds to a beamformed signal of the respective waveform.

Aspect 10: The apparatus of any of aspects 1 through 9, wherein the instructions are further executable by the processor to cause the apparatus to determine timing information for charging of the source associated with the UE based at least in part on a radio resource control configuration or a MAC-CE, the timing information indicating a charging time interval for the charging of the source associated with the UE, the charging time interval comprising a beginning period and an ending period, and the MAC-CE activating or deactivating the charging of the source associated with the UE.

Aspect 11: The apparatus of aspect 10, wherein the timing information for charging of the source associated with the UE is based at least in part on data traffic between the network entity and the UE.

Aspect 12: The apparatus of any of aspects 10 through 11, wherein the instructions are further executable by the processor to cause the apparatus to transmit feedback information that indicates a respective waveform, a frequency associated with the respective waveform, or a set of spatial parameters, or a combination thereof, wherein the respective energy charge rate is based at least in part on the respective waveform, the frequency associated with the respective waveform, the set of spatial parameters, or a combination thereof.

Aspect 13: The apparatus of any of aspects 1 through 12, wherein the instructions are further executable by the processor to cause the apparatus to receive control signaling that indicates a respective waveform associated with the respective mode, wherein the respective waveform corresponds to an uplink waveform, a downlink waveform, or both; and communicate with the network entity in accordance with the uplink waveform, the downlink waveform, or both.

Aspect 14: The apparatus of aspect 13, wherein the instructions are further executable by the processor to cause the apparatus to select the respective waveform from a set of waveforms based at least in part on the received control signaling and the respective mode associated with the respective waveform.

Aspect 15: The apparatus of any of aspects 13 through 14, wherein the instructions are further executable by the processor to cause the apparatus to determine a time interval associated with use of the respective waveform based at least in part on the received control signaling, wherein communicate with the network entity is based at least in part on the determined time interval associated with the use of the respective waveform.

Aspect 16: The apparatus of any of aspects 13 through 15, wherein the instructions to receive the control signaling are executable by the processor to cause the apparatus to receive a radio resource control message that indicates the respective waveform associated with the respective mode.

Aspect 17: The apparatus of any of aspects 13 through 16, wherein the instructions to receive the control signaling are executable by the processor to cause the apparatus to receive a MAC-CE that indicates the respective waveform associated with the respective mode, the MAC-CE activating or deactivating the respective waveform associated with the respective mode.

Aspect 18: The apparatus of any of aspects 13 through 17, wherein the instructions to receive the control signaling are executable by the processor to cause the apparatus to receive a downlink control information that indicates the respective waveform associated with the respective mode, the downlink control information activating or deactivating the respective waveform associated with the respective mode.

Aspect 19: The apparatus of any of aspects 13 through 18, wherein the instructions are further executable by the processor to cause the apparatus to determine an offset time interval for switching to the respective waveform based at least in part on the received configuration, wherein the offset time interval is based at least in part on a type of the respective waveform, the type of respective waveform corresponding to downlink or uplink, or both.

Aspect 20: The apparatus of any of aspects 1 through 19, wherein the instructions are further executable by the processor to cause the apparatus to receive, from the network entity, a discontinuous reception configuration comprising one or more discontinuous reception parameters associated with the respective mode, timing information recommended by the UE, a resource allocation preferred by the UE, a power allocation preferred by the UE, or a combination thereof, wherein receive the signal is based at least in part on the received discontinuous reception configuration.

Aspect 21: The apparatus of any of aspects 1 through 20, wherein the instructions are further executable by the processor to cause the apparatus to accumulate energy based at least in part on the received signal, wherein charging of the source associate with the UE is based at least in part on the accumulated energy.

Aspect 22: The apparatus of any of aspects 1 through 21, wherein the signal comprises an electromagnetic wave in a radio frequency spectrum or an optical spectrum of an electromagnetic spectrum.

Aspect 23: The apparatus of aspect 1 through 22, wherein the respective mode corresponds to a type of UE, and the UE corresponds to the type of UE.

Aspect 24: The apparatus of aspect 23, wherein the type of UE corresponds to a type of energy harvesting circuit requirement, a transfer requirement, or a charging rate requirement, or any combination thereof.

Aspect 25: The apparatus of any of aspects 1 through 24, wherein each mode of the set of modes associated with the network entity corresponds to a respective waveform of a set of waveforms.

Aspect 26: The apparatus of any of aspects 1 through 25, wherein a first subset of modes corresponds to transfer supported by the network entity and a second subset of modes corresponds to transfer unsupported by the network entity.

Aspect 27: A method for wireless communication at a UE, comprising: receiving, from a network entity, signaling indicating a configuration associated with a respective mode of a set of modes, the respective mode corresponding to a respective transfer supported by the network entity and a respective charging rate associated with the respective transfer; receiving, from the network entity, a signal based at least in part on the indicated configuration, wherein the signal corresponds to the respective transfer; and charging of a source associated with the UE based at least in part on the received signal and in accordance with the respective charging rate associated with the respective transfer.

Aspect 28: The method of aspect 27, further comprising: receiving a control signal that enables the charging of the source associated with the UE, the control signal comprises one or more of a L1 signal, a L2 signal, or a L3 signal, wherein charging of the source associated with the UE is based at least in part on the received control signal.

Aspect 29: The method of any of aspects 27 through 28, further comprising: receiving a control signal that disables the charging of the source associated with the UE, the control signal comprises one or more of a L1 signal, a L2 signal, or a L3 signal; and terminating the charging of the source associated with the UE based at least in part on the received control signal.

Aspect 30: The method of any of aspects 27 through 29, wherein charging of the source associated with the UE is based at least in part on the configuration and irrespective of one or more of a L1 signal, a L2 signal, or a L3 signal enabling or disabling the charging of the source.

Aspect 31: The method of any of aspects 27 through 30, further comprising: determining a respective waveform for the respective mode based at least in part on the configuration, the received signal corresponds to the determined respective waveform, and the determined respective waveform corresponds to the respective charging rate, wherein charging of source associated with the UE is based at least in part on the determined respective waveform.

Aspect 32: The method of aspect 31, wherein the determined respective waveform comprises a narrowband waveform or a broadband waveform.

Aspect 33: The method of any of aspects 31 through 32, wherein the determined respective waveform corresponds to a respective frequency based at least in part on the respective charging rate.

Aspect 34: The method of any of aspects 31 through 33, wherein the received signal corresponds to a beamformed signal of the respective waveform.

Aspect 35: The method of any of aspects 27 through 34, further comprising: determining timing information to charge the source associated with the UE based at least in part on a radio resource control configuration or a MAC-CE, the timing information indicating a charging time interval for the charging of the source associated with the UE, the charging time interval comprising a beginning period and an ending period, and the MAC-CE activating or deactivating the charging of the source associated with the UE.

Aspect 36: The method of aspect 35, wherein the timing information to charge the source associated with the UE is based at least in part on data traffic between the network entity and the UE.

Aspect 37: The method of any of aspects 35 through 36, further comprising: transmitting feedback information that indicates a respective waveform, a frequency associated with the respective waveform, or a set of spatial parameters, or a combination thereof, wherein the respective charging rate is based at least in part on the respective waveform, the frequency associated with the respective waveform, the set of spatial parameters, or a combination thereof.

Aspect 38: The method of any of aspects 27 through 37, further comprising: receiving control signaling that indicates a respective waveform associated with the respective mode, wherein the respective waveform corresponds to an uplink waveform, a downlink waveform, or both; and communicating with the network entity in accordance with the uplink waveform, the downlink waveform, or both.

Aspect 39: The method of aspect 38, further comprising: selecting the respective waveform from a set of waveforms based at least in part on the received control signaling and the respective mode associated with the respective waveform.

Aspect 40: The method of any of aspects 38 through 39, further comprising: determining a time interval associated with use of the respective waveform based at least in part on the received control signaling, wherein communicating with the network entity is based at least in part on the determined time interval associated with the use of the respective waveform.

Aspect 41: The method of any of aspects 38 through 40, wherein receiving the control signaling comprises: receiving a radio resource control message that indicates the respective waveform associated with the respective mode.

Aspect 42: The method of any of aspects 38 through 41, wherein receiving the control signaling comprises: receiving a MAC-CE that indicates the respective waveform associated with the respective mode, the MAC-CE activating or deactivating the respective waveform associated with the respective mode.

Aspect 43: The method of any of aspects 38 through 42, wherein receiving the control signaling comprises: receiving a DCI that indicates the respective waveform associated with the respective mode, the DCI activating or deactivating the respective waveform associated with the respective mode.

Aspect 44: The method of any of aspects 38 through 43, further comprising: determining an offset time interval for switching to the respective waveform based at least in part on the configuration, wherein the offset time interval is based at least in part on a type of the respective waveform, the type of respective waveform corresponding to downlink or uplink, or both.

Aspect 45: The method of any of aspects 27 through 44, further comprising: receiving, from the network entity, a DRX configuration comprising one or more DRX parameters associated with the respective mode, timing information recommended by the UE, a resource allocation preferred by the UE, a power allocation preferred by the UE, or a combination thereof, wherein receiving the signal is based at least in part on the received DRX configuration.

Aspect 46: The method of any of aspects 27 through 45, further comprising: accumulating energy based at least in part on the received signal, wherein charging of the source associated with the UE is based at least in part on the accumulated energy.

Aspect 47: The method of any of aspects 27 through 46, wherein the signal comprises an EM wave in a radio frequency spectrum or an optical spectrum of an EM spectrum.

Aspect 48: The method of any of aspects 27 through 47, wherein the respective mode corresponds to a type of UE, and the UE corresponds to the type of UE.

Aspect 49: The method of aspect 48, wherein the type of UE corresponds to a type of energy harvesting circuit requirement, a transfer requirement, or a charging rate requirement, or any combination thereof.

Aspect 50: The method of any of aspects 27 through 49, wherein each mode of the set of modes associated with the network entity corresponds to a respective waveform of a set of waveforms.

Aspect 51: The method of any of aspects 27 through 50, wherein a first subset of modes corresponds to transfer supported by the network entity and a second subset of modes corresponds to transfer unsupported by the network entity.

Aspect 52: A method for wireless communication at a network entity, comprising: outputting signaling indicating a configuration associated with a respective mode of a set of modes, the respective mode corresponding to a respective transfer supported by the network entity and a respective charging rate associated with the respective transfer; and outputting a signal based at least in part on the indicated configuration, wherein the signal corresponds to the respective transfer.

Aspect 53: The method of aspect 52, wherein each mode of the set of modes associated with the network entity corresponds to a respective waveform of a set of waveforms.

Aspect 54: The method of any of aspects 52 through 53, wherein a first subset of modes corresponds to transfer supported by the network entity and a second subset of modes corresponds to transfer unsupported by the network entity.

Aspect 55: The method of any of aspects 52 through 54, further comprising: transmitting a control signal that enables the charging of the source associated with a UE, the control signal comprises one or more of a L1 signal, a L2 signal, or a L3 signal.

Aspect 56: The method of any of aspects 52 through 55, further comprising: transmitting a control signal that disables the charging of the source associated with a UE, the control signal comprises one or more of a L1 signal, a L2 signal, or a L3 signal.

Aspect 57: The method of any of aspects 52 through 56, further comprising: receiving feedback information that indicates a respective waveform, a frequency associated with the respective waveform, or a set of spatial parameters, or a combination thereof.

Aspect 58: The method of any of aspects 52 through 57, further comprising: transmitting control signaling that indicates a respective waveform associated with the respective mode, wherein the respective waveform corresponds to an uplink waveform, a downlink waveform, or both.

Aspect 59: The method of aspect 58, further comprising: transmitting a radio resource control message that indicates the respective waveform associated with the respective mode.

Aspect 60: The method of any of aspects 58 through 59, further comprising: transmitting a MAC-CE that indicates the respective waveform associated with the respective mode, the MAC-CE activating or deactivating the respective waveform associated with the respective mode.

Aspect 61: The method of any of aspects 58 through 60, further comprising: transmitting a DCI that indicates the respective waveform associated with the respective mode, the DCI activating or deactivating the respective waveform associated with the respective mode.

Aspect 62: The method of any of aspects 52 through 61, further comprising: transmitting a DRX configuration comprising one or more DRX parameters associated with the respective mode, timing information recommended by a UE, a resource allocation preferred by the UE, a power allocation preferred by the UE, or a combination thereof.

Aspect 63: An apparatus for wireless communication at a UE, comprising at least one means for performing a method of any of aspects 27 through 51.

Aspect 64: A non-transitory computer-readable medium storing code for wireless communication at a UE, the code comprising instructions executable by a processor to perform a method of any of aspects 27 through 51.

Aspect 65: An apparatus for wireless communication at a network entity, comprising at least one means for performing a method of any of aspects 52 through 62.

Aspect 66: A non-transitory computer-readable medium storing code for wireless communication at a network entity, the code comprising instructions executable by a processor to perform a method of any of aspects 52 through 62.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, EM waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor configured to:
receive, from a network entity, signaling that indicates a configuration associated with a first mode of a set of modes, the first mode corresponding to a first transfer supported by the network entity and a first charging rate associated with the first transfer;
receive, from the network entity, a signal based at least in part on the indicated configuration, wherein the signal corresponds to the first transfer; and
charge a source associated with the UE based at least in part on the received signal and in accordance with the first charging rate associated with the first transfer.

2. The apparatus of claim 1, wherein the processor is further configured to:
receive a control signal that enables charging the source associated with the UE, wherein the control signal comprises one or more of a layer-1 signal, a layer-2 signal, or a layer-3 signal,
wherein to charge the source associate with the UE is based at least in part on the received control signal.

3. The apparatus of claim 1, wherein the processor is further configured to:
receive a control signal that disables charging the source associated with the UE, wherein the control signal comprises one or more of a layer-1 signal, a layer-2 signal, or a layer-3 signal; and
terminate charging the source associated with the UE based at least in part on the received control signal.

4. The apparatus of claim 1, wherein to charge the source associated with the UE is based at least in part on the configuration and irrespective of one or more of a layer-1 signal, a layer-2 signal, or a layer-3 signal enabling or disabling the charging of the source.

5. The apparatus of claim 1, wherein the set of modes comprises power modes, power saving modes, energy saving modes, communications modes, or a combination thereof, wherein the first transfer comprises a power transfer, an energy transfer, or both, wherein the signal comprises a power signal, an energy signal, or both, and wherein the charging rate comprises a power charging rate, an energy charging rate, or both.

6. The apparatus of claim 1, wherein the processor is further configured to:
determine a first waveform for the first mode based at least in part on the configuration, wherein the received signal corresponds to the determined first waveform, and the determined first waveform corresponds to the first charging rate,
wherein to charge the source associate with the UE is based at least in part on the determined first waveform.

7. The apparatus of claim 6, wherein the determined first waveform comprises a narrowband waveform or a broadband waveform.

8. The apparatus of claim 6, wherein the determined first waveform corresponds to a first frequency based at least in part on the first charging rate.

9. The apparatus of claim 6, wherein the received signal corresponds to a beamformed signal of the first waveform.

10. The apparatus of claim 1, wherein the processor is further configured to:
determine timing information to charge the source associated with the UE based at least in part on a radio resource control configuration or a medium access control-control element (MAC-CE), wherein the timing information indicates a charging time interval to charge the source associated with the UE, wherein the charging time interval comprises a begin period and an end period, and wherein the MAC-CE activates or deactivates charging the source associated with the UE.

11. The apparatus of claim 10, wherein the timing information to charge the source associated with the UE is based at least in part on data traffic between the network entity and the UE.

12. The apparatus of claim 10, wherein the processor is further configured to:
transmit feedback information that indicates a first waveform, a frequency associated with the first waveform, or a set of spatial parameters, or a combination thereof,
wherein the first charging rate is based at least in part on the first waveform, the frequency associated with the first waveform, the set of spatial parameters, or a combination thereof.

13. The apparatus of claim 1, further comprising:
an antenna coupled with the processor,
wherein the processor is further configured to:
receive control signaling that indicates a first waveform associated with the first mode, wherein the first waveform corresponds to an uplink waveform, a downlink waveform, or both; and
communicate with the network entity in accordance with the uplink waveform, the downlink waveform, or both.

14. The apparatus of claim 13, wherein the processor is further configured to:
select the first waveform from a set of waveforms based at least in part on the received control signaling and the first mode associated with the first waveform.

15. The apparatus of claim 13, wherein the processor is further configured to:
determine a time interval associated with use of the first waveform based at least in part on the received control signaling,
wherein to communicate with the network entity is based at least in part on the determined time interval associated with the use of the first waveform.

16. The apparatus of claim 13, wherein, to receive the control signaling, the processor is configured to:
receive a radio resource control message that indicates the first waveform associated with the first mode.

17. The apparatus of claim 13, wherein, to receive the control signaling, the processor is configured to:
receive a medium access control-control element (MAC-CE) that indicates the first waveform associated with the first mode, wherein the MAC-CE activates or deactivates the first waveform associated with the first mode.

18. The apparatus of claim 13, wherein, to receive the control signaling, the processor is configured to:
receive a downlink control information that indicates the first waveform associated with the first mode, wherein the downlink control information activates or deactivates the first waveform associated with the first mode.

19. The apparatus of claim 13, wherein the processor is further configured to:
determine an offset time interval to switch to the first waveform based at least in part on the configuration, wherein the offset time interval is based at least in part on a type of the first waveform, the type of first waveform corresponds to downlink or uplink, or both.

20. The apparatus of claim 1, wherein the processor is further configured to:
receive, from the network entity, a discontinuous reception configuration that comprises one or more discontinuous reception parameters associated with the first mode, timing information recommended by the UE, a resource allocation preferred by the UE, a power allocation preferred by the UE, or a combination thereof,
wherein to receive the signal is based at least in part on the received discontinuous reception configuration.

21. The apparatus of claim 1, wherein the processor is further configured to:
accumulate energy based at least in part on the received signal,
wherein to charge the source associate with the UE is based at least in part on the accumulated energy.

22. The apparatus of claim 1, wherein the signal comprises an electromagnetic wave in a radio frequency spectrum or an optical spectrum of an electromagnetic spectrum.

23. The apparatus of claim 1, wherein:
the first mode corresponds to a type of UE, and
the UE corresponds to the type of UE.

24. The apparatus of claim 23, wherein the type of UE corresponds to a type of energy harvesting circuit requirement, a transfer requirement, or a charging rate requirement, or any combination thereof.

25. The apparatus of claim 1, wherein each mode of the set of modes associated with the network entity corresponds to a first waveform of a set of waveforms.

26. The apparatus of claim 1, wherein a first subset of modes corresponds to transfer supported by the network entity and a second subset of modes corresponds to transfer unsupported by the network entity.

27. An apparatus for wireless communication at a network entity, comprising:
a processor; and
memory coupled with the processor, the processor configured to:
output signaling that indicates a configuration associated with a first mode of a set of modes, the first mode corresponds to a first transfer supported by the network entity and a first charging rate associated with the first transfer; and
output a signal based at least in part on the indicated configuration, wherein the signal corresponds to the first transfer.

28. The apparatus of claim 27, wherein each mode of the set of modes associated with the network entity corresponds to a first waveform of a set of waveforms.

29. A method for wireless communication at a user equipment (UE), comprising:
receiving, from a network entity, signaling indicating a configuration associated with a first mode of a set of modes, the first mode corresponding to a first transfer supported by the network entity and a first charging rate associated with the first transfer;
receiving, from the network entity, a signal based at least in part on the indicated configuration, wherein the signal corresponds to the first transfer; and
charging a source associated with the UE based at least in part on the received signal and in accordance with the first charging rate associated with the first transfer.

30. A method for wireless communication at a network entity, comprising:
outputting signaling indicating a configuration associated with a first mode of a set of modes, the first mode corresponding to a first transfer supported by the network entity and a first charging rate associated with the first transfer; and
outputting a signal based at least in part on the indicated configuration, wherein the signal corresponds to the first transfer.
